(19) United States
(12) Patent Application Publication
(10) Pub. No.: US 2013/0247308 A1
(43) Pub. Date: Sep. 26, 2013

(54) LAUNDRY DETERGENT COMPOSITION FOR LOW TEMPERATURE WASHING AND DISINFECTION

(71) Applicants: Thomas J. Duerrschmidt, Hilden (DE); Thomas Merz, Hilden (DE); Peter J. Forth, Duesseldorf (DE); Chris Nagel, St. Paul, MN (US); Amila Bilic, Oberhausen (DE)

(72) Inventors: Thomas J. Duerrschmidt, Hilden (DE); Thomas Merz, Hilden (DE); Peter J. Forth, Duesseldorf (DE); Chris Nagel, St. Paul, MN (US); Amila Bilic, Oberhausen (DE)

(73) Assignee: Ecolab USA Inc., St. Paul, MN (US)

(21) Appl. No.: 13/878,356

(22) PCT Filed: Oct. 8, 2010
(86) PCT No.: PCT/EP2010/065057

§ 371 Date: Jun. 13, 2013

(51) Int. Cl. C11D 3/395; C11D 1/72; C11D 3/20; C11D 1/825

(52) U.S. Cl. CPC C11D 3/3951; C11D 1/8255; C11D 1/72; C11D 3/2075
USPC 8/137; 510/356; 510/355; 510/310; 510/309

(57) ABSTRACT

The invention relates to a low temperature detergent composition of a first component for cleaning and disinfecting comprising:
(a) about ≧2 wt.-% to about ≦50 wt.-% of a nonionic low alkoxylated alcohol tenside containing 1 to 2 alkylene oxide units;
(b) about ≧0 wt.-% to about ≦60 wt.-% of nonionic higher alkoxylated alcohol tenside containing 3 to 40 alkylene oxide units;
(c) about ≧1 wt.-% to about ≦60 wt.-% of a source of alkalinity;
(d) about ≧0 wt.-% to about ≦95 wt.-% of at least one solvent; calculated on the total weight amount of the detergent composition of the first component.

The invention relates further to a low temperature detergent composition for cleaning and disinfecting of a first component composition and a second component composition containing at least one bleaching agent.

### FIELD OF THE INVENTION

The present patent application relates to a detergent composition for low temperature washing and disinfection, which on its use contributes to a reduction in the germs count, such as bacteria, fungi, virus and spores, of the washing washed with it. Further, the present invention relates to a method for removing soil from a textile as well as significantly reducing the germs count, such as bacteria, fungi, virus and spores, at low washing temperature comprising a washing and a bleaching step.

### BACKGROUND OF THE INVENTION

Removing stains or soils, particularly hydrophobic soils, typically requires machine washing of laundry item at temperatures above 60° C. or at 95° C. “so-called boiling washes”. Under these conditions, a marked reduction in the germs count, such as bacteria, fungi, virus and spores, of the thus treated washing is observed and the washing machine is disinfected without any problem. On the other hand, most washed materials do not support the conditions of a boiling wash. On the contrary, there is an increasing trend towards so-called low maintenance and functional laundry item, which can only be washed at washing temperatures from 30° C. or 40° C. at the most. At these temperatures, an efficient disinfection using known laundry detergent compositions is not always satisfactorily guaranteed, particularly if the washing machine remains unused for some time.

The use of an increased amount of bleaching agents in order to boost the disinfecting effect of the detergent leads to an oxidative discoloration, even at these low temperatures. The danger of a deleterious effect on the laundry item increases further when the laundry item has been impregnated. Also, on washing so-called functional laundry item, which consist of several layers of textured synthetic fibers in the form of knitted or woven fabrics, generally including micro porous or hydrophilic membranes of materials or micro fine capillary knitted fabrics, high demands are set for a gentle action of the washing agent being used.

Further, laundry and dry cleaners requires machine washing at temperatures of at 60° C. or higher to sufficiently clean and disinfect huge amounts of laundry item receipt from hotels and hospitals. Lowering the washing temperature to a washing temperature ≦40° C. remarkably lowers the need of energy.

Accordingly, there exists a requirement for a washing agent, which when used even at low temperature wash cycles, leads to a sufficient removing of stains and/or soils and exhibit a significant reduction in the germs count, such as bacteria, fungi, virus and spores, of the washing, neither damaging the laundry item material nor the color of the treated laundry item.

### SUMMARY OF THE INVENTION

The object of the present invention is to provide a first component of a low temperature active detergent composition for removing soils from laundry item, which on its use contributes to a reduction in the germs count, such as bacteria, fungi, virus and spores, of the washing washed with it.

The object is solved by providing a low temperature detergent composition of a first component for cleaning and disinfecting comprising:
(a) about ≧2 wt.-% to about ≦50 wt.-% of a nonionic low alkoxylated alcohol tenside containing 1 to 2 alkylene oxide units;
(b) about ≧0 wt.-% to about ≦60 wt.-% of nonionic higher alkoxylated alcohol tenside containing 3 to 40 alkylene oxide units;
(c) about ≧1 wt.-% to about ≦60 wt.-% of a source of alkalinity;
(d) about >0 wt.-% to about ≦95 wt.-% of at least one solvent; calculated on the total weight amount of the detergent composition of the first component.

According to a preferred embodiment of the invention the ratio of (a) low ethoxylated alcohol to (c) source of alkalinity can be in the range of about 20:1 to about 1:6.

The weight percent (wt.-%) is calculated on the total weight amount of the low temperature detergent composition of the first component, if related thereto, or on the total weight amount of the second component, if related thereto. Further, the total weight amount of all component of the first component is selected such, that it does not exceed 100 wt.-% and the total weight amount of all component of the first component is selected such, that it does not exceed 100 wt.-%.

The ratio of components is parts by weight, if not otherwise stated.

The detergent composition of the first component of the invention, referred to as “washing composition”, effectively cleans and supports disinfection of a laundry item in a time suitable for cleaning a textile.

Another object of the present invention is to provide a two component detergent compositions for low temperature washing and disinfection, containing a detergent composition of the first component and a second component containing at least one bleaching agent.

It should be understood that a bleaching agent need not to be present in the composition of the first component of the invention. It can be preferred that the composition of the first component of the invention does not contain a bleaching agent.

The detergent composition of the first component and second bleaching component of the invention improves cleaning and disinfecting of a laundry item.

Preferably, the detergent composition of the first component and/or second bleaching component of the invention can be present in a liquid form. With respect to facilitate the addition of the first and second component of the invention into the rinsing chamber of a washing machine or their transfer into one of the compartment of a wash tunnel both components, i.e. first component and second component are a liquid.

Another object of the present invention is to provide a method for removing soil from a laundry item as well as significantly reducing the germs count, such as bacteria, fungi, virus and spores, at low washing temperature.

This method can include a bleaching step that favors bleaching and disinfection and a washing step for cleaning and disinfection of a laundry item with a detergent composition; bleaching and washing the laundry item with the detergent composition of the invention at low temperature, thus removing the soil and reducing the germs count, such as bacteria, fungi, virus and spores, from the laundry item.

The method for treating laundry of the invention includes steps of applying a bleaching composition of the second component that shows bleaching and disinfecting properties and a cleaning and disinfection composition of the first component to laundry item in a laundry washing machine that favors cleaning and disinfection. The pH at the bleaching step and the pH at the washing step may be different. The step of applying a bleaching composition of second component can precede or follow a step of washing laundry with the cleaning and disinfection composition of first component for the removal of soil and reduction in the germs count, such as bacteria, fungi, virus and spores, of the laundry washed with it. Finally, the method for treating laundry comprises draining the bleaching and washing composition from the laundry.

The nonionic low alkoxylated alcohol tenside containing 1 to 2 alkylene oxide units shows an increased reduction in the germs count, such as bacteria, fungi, virus and spores, of laundry items washed with it. Thus, the nonionic low alkoxylated alcohol tenside containing 1 to 2 alkylene oxide units replaces at least partly the bleaching agent. Due to this effect, the amount of bleaching agent, that is the second component of the invention, can be reduced in a wash process involving the first component of the invention. Therefore, the composition of the present invention neither damages the textile material nor the color of the treated textiles even with so-called functional textiles, does not cause any running of the colors and provides an antistatic finish as well as a soft feel to the washed textiles and the retention of an eventual hydrophobic impregnation.

### DETAILED DESCRIPTION OF THE INVENTION

As used herein, the phrase “low temperature” refers to a temperature of about 40° C. at the most. As used herein, the phrase “laundry item” or “washing” refers to an item made from or including textile, woven fabric, non-woven fabric, or knitted fabrics. The laundry item can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Exemplary treated fibers include those treated for flame retardancy. It should be understood that the term “linen” is often used to describe certain types of laundry items including bed sheets, pillow cases, towels, table linen, table cloth, bar mops and uniforms.

The composition and method of the invention can also be used for treating non-laundry articles and surfaces including hard surfaces such as dishes, glasses, and other ware.

The detergent composition of the first component of the invention may comprise additional ingredients such as cationic tensides, anionic surfactant, e.g., phosphate ester, alkyl amine oxide, nonionic surfactant, e.g. polyoxyethylene-polyoxypropylene block copolymer, plasticizer and/or perfume or mixtures thereof. However, cationic tensides are less preferred and the first component of the invention can be free of cationic tensides. Anionic tensides can be added to the first component of the invention. It should be understood that the addition of anionic tensides is optional, thus the composition of the first component can be free of anionic tensides.

The detergent composition of the first component of the invention may include additional ingredients or forms of ingredients found in laundry detergents such as bleaching agents, perfume, optical brightener, chelants and/or thickening agents.

In order to optimize the reduction in the germs count, such as bacteria, fungi, virus and spores, of the laundry item washed with the detergent composition of the first component of invention, the ratio of (a) low ethoxylated alcohol to (c) source of alkalinity can be in the range of about 19:1 to about 1:6, about 18:1 to about 1:6, about 17:1 to about 1:6, about 16:1 to about 1:6, about 15:1 to about 1:6, about 14:1 to about 1:6, about 13:1 to about 1:6, about 12:1 to about 1:6, about 11:1 to about 1:6, about 10:1 to about 1:6, 9:1 to about 1:6, 8:1 to about 1:6, about 7:1 to about 1:6, about 6:1 to about 1:6, about 5:1 to about 1:6, about 4:1 to about 1:6, about 3:1 to about 1:6, about 2:1 to about 1:6, about 1:1 to about 1:6, about 1:1 to about 1:5, about 1:1 to about 1:4, about 1:1 to about 1:3, and about 1:1 to about 1:2. The ratio of the components (a) and (c) are selected such, that the total weight of the composition of the first component does not exceed 100 wt.-%.

The cleaning properties of the first component of the invention can be increased by adjusting the ratio of component (a) to component (b) to an desired value. The ratio of (a) low ethoxylated alcohol to (b) of nonionic higher alkoxylated alcohol tenside can be adjusted in the range from about 8:1 to about 1:20, preferably about 7:1 to about 1:18, further preferred about 6:1 to about 1:16, also preferred about 5:1 to about 1:14, furthermore preferred about 4:1 to about 1:12, and more preferred about 3:1 to about 1:10. In addition, the ratio of (a) low ethoxylated alcohol to (b) of nonionic higher alkoxylated alcohol tenside can be adjusted in the range from about 2:1 to about 1:8, about 1:1 to about 1:6, about 1:1 to about 1:4 and about 1:1 to about 1:2. However, most preferred is the ratio of component (a) to component (b) in the range from about 1:2 to about 1:3.

The detergent composition of the first component can be provided in the form of a concentrate that is diluted with water to provide a use solution. The use solution can be used for washing articles such as laundry items.

### Nonionic Low Alkoxylated Alcohol Tensides

The nonionic low alkoxylated alcohol tensides provide for enhancing the cleaning and disinfecting properties of the use solution. The nonionic low alkoxylated alcohol tensides can be used to reduce surface tension, wet the soil particulate to allow penetration of the use solution, separation of the soil and contribute a remarkable reduction in the germs count, such as bacteria, fungi, virus and spores, of the laundry item washed with it.

Exemplary nonionic low alkoxylated alcohol tensides in the composition of the first component according to the invention are alkoxylated alcohols containing 1 to 2 ethylene oxide groups (1-2EO) and most preferred 2 ethylene oxide (2EO) groups, or mixtures thereof.

Advantageously low ethoxylated alcohols useful in the composition of the first component according to the invention are particularly primary and/or branched alcohols, preferably containing 8 to 18 carbon atoms, and containing 1 to 2 ethylene oxide groups (1-2EO), and most preferred 2 ethylene oxide groups (2EO), or may contain a mixture. The alcohol radical may be linear, branched, or may contain a mixture.

Particularly preferred low ethoxylated alcohols of the composition of the first component according to the invention are, however, alcohol ethoxylates with linear radicals of alcohols of natural origin with 12 to 18 carbon atoms, e.g. from coco-, palm-, tallow- or oleyl alcohol, containing 1 to 2 ethylene oxide groups (1-2EO) and most preferred are 2 ethylene oxide groups (2EO), or a mixture of different compounds thereof. However, most preferred is isotridecyl alcohol in the composition of the first component of the invention with 1EO to 2EO and most preferred 2EO, or a mixture of different compounds thereof.

Exemplary low ethoxylated alcohols with 1EO to 2EO and most preferred 2EO include C₁₂-C₁₄-alcohols; C₉-C₁₁-alcohols, C₁₃-C₁₅— alcohols, C₁₂-C₁₈-alcohols and mixtures thereof, as well as mixtures of C₁₂-C₁₄-alcohols and C₁₂-C₁₈-alcohols and most preferred is a C₁₃-alcohol.

The degrees of 1EO to 2EO and most preferred 2EO ethoxylation mentioned are statistical mean values, which for a special product, may be either a whole number or a fractional number. However, more preferred, the degrees of 1EO to 2EO and most preferred 2EO ethoxylation mentioned may be either a whole number or a fractional number. Most preferred, the degrees of 1EO to 2EO and most preferred 2EO ethoxylation mentioned may be a whole number.

Preferred lower ethoxylated alcohols have a narrow homolog distribution (narrow range ethoxylates, NRE).

The nonionic low alkoxylated alcohol tenside containing 1 to 2 alkylene oxide units can be provided in the composition of the first component in an amount of about ≧1 wt.-% to about ≦65 wt.-%, preferably about ≧1 wt.-% to about ≦45 wt.-%, further preferred about ≧1 wt.-% to about ≦35 wt.-%, also preferred about ≧1 wt.-% to about ≦25 wt.-%, furthermore preferred about ≧2 wt.-% to about ≦20 wt.-%, in addition preferred about ≧3 wt.-% to about ≦15 wt.-%, more preferred about ≧4 wt.-% to about ≦10 wt.-% and most preferred about ≧5 wt.-% to about ≦8 wt.-% based on the weight of the total first component.

### Nonionic Higher Alkoxylated Alcohol Tensides

Exemplary nonionic higher alkoxylated alcohol tensides in the composition of the first component according to the invention are alkoxylated alcohols containing 3 to 40 ethylene oxide groups (5-40EO), preferably 6 to 30 ethylene oxide groups (6-30EO), further preferred 7 to 20 ethylene oxide groups (7-20EO), more preferred 8 to 10 ethylene oxide groups (8-10EO), and most preferred 8 ethylene oxide (8EO) groups, or mixtures thereof.

Advantageously higher ethoxylated alcohols useful in the composition of the first component according to the invention are particularly linear and/or branched alcohols, preferably containing 8 to 18 carbon atoms, and 3 to 40 ethylene oxide groups (3-40EO), preferably 6 to 30 ethylene oxide groups (6-30EO), further preferred 7 to 20 ethylene oxide groups (7-20EO), more preferred 8 to 10 ethylene oxide groups (8-10EO), and most preferred 8 ethylene oxide groups (8EO), or may contain a mixture. The alcohol radical may be linear, branched, or may contain a mixture.

Particularly preferred higher ethoxylated alcohols of the composition of the first component according to the invention are, however, alcohol ethoxylates with linear or branched radicals of alcohols with 12 to 18 carbon atoms, e.g. from coco-, palm-, tallow- or oleyl alcohol, containing 8 to 18 carbon atoms, and 3 to 40 ethylene oxide groups (3-40EO), preferably 6 to 30 ethylene oxide groups (6-30EO), further preferred 7 to 20 ethylene oxide groups (7-20EO), more preferred 8 to 10 ethylene oxide groups (8-10EO), and most preferred 8 ethylene oxide groups (8EO), or may contain a mixture. However, most preferred is isotridecyl alcohol in the composition of the first component of the invention with 6EO to 14EO, preferably 7EO to 10EO, and most preferred 8EO, or may contain a mixture.

According to the present invention higher ethoxylated alcohols can be used with 3EO, 4EO, 5EO, 6EO, 7EO, 8EO, 9EO, 10EO, 11EO, 12EO, 13EO, 14EO, 15EO, 16EO, 17EO, 18EO, 19EO, 20EO, 21EO, 22EO, 23EO, 24EO or 25EO, or may contain a mixture.

Exemplary higher ethoxylated alcohols with 3EO to 40EO, preferably 6EO to 30EO, further preferred 7EO to 20EO, more preferred 8EO to 10 EO and most preferred 8EO include C₁₂-C₁₄-alcohols; C₉-C₁₁-alcohols, C₁₃-C₁₅-alcohols, C₁₂-C₁₈-alcohols and mixtures thereof, as well as mixtures of C₁₂-C₁₄-alcohols and C₁₂-C₁₈-alcohols and most preferred is a C₁₃-alcohol.

In addition to these nonionic tensides, fatty alcohols containing more than 12 EO may also be used. Examples of such fatty alcohols are tallow fatty alcohol containing 14 EO, 25 EO, 30 EO or 40 EO.

The degrees of 3EO to 40EO, preferably 6EO to 30EO, further preferred 7EO to 20EO, more preferred 8EO to 10 EO and most preferred 8EO ethoxylation mentioned are statistical mean values, which for a special product, may be either a whole number or a fractional number. However, more preferred, the degrees of 3EO to 40EO, preferably 6EO to 30EO, further preferred 7EO to 20EO, more preferred 8EO to 10 EO and most preferred 8EO ethoxylation mentioned may be either a whole number or a fractional number. Most preferred, the degrees of 3EO to 40EO, preferably 6EO to 30EO, further preferred 7EO to 20EO, more preferred 8EO to 10 EO and most preferred 8EO ethoxylation mentioned may be a whole number.

Preferred higher ethoxylated alcohols have a narrow homolog distribution (narrow range ethoxylates, NRE).

The nonionic higher alkoxylated alcohol tenside containing 3 to 40 alkylene oxide units can be provided in the composition of the first component in an amount of about >0 wt.-% to about ≦60 wt.-%, preferably about >1 wt.-% to about ≦55 wt.-%, further preferred about >3 wt.-% to about ≦50 wt.-%, also preferred about >5 wt.-% to about ≦40 wt.-%, furthermore preferred about >7 wt.-% to about ≦30 wt.-%, in addition preferred about >9 wt.-% to about ≦25 wt.-%, and more preferred about >11 wt.-% to about ≦20 wt.-%, based on the weight of the total first component.

### Additional Surfactant Component

The additional surfactant component provides for enhancing the cleaning properties of the use solution. The surfactant component can be used to reduce surface tension and wet the soil particulate to allow penetration of the use solution and separation of the soil. The surfactant component can include anionic surfactants, nonionic surfactants, but other than (a) nonionic lower alkoxylated alcohol tenside and (b) nonionic higher alkoxylated alcohol tenside mentioned above, amphoteric surfactants and mixtures thereof.

### Additional Nonionic Surfactant

Exemplary nonionic surfactants that can be used in the composition of the first component of the invention are alkoxylated, preferably ethoxylated or ethoxylated and propoxylated, fatty acid alkyl esters preferably containing 1 to 4 carbon atoms in the alkyl chain, more particularly the fatty acid methyl esters.

Further surfactants include ethoxylated long chain fatty acid amides where the fatty acid has 8-20 carbon atoms and the amide group is ethoxylated with 1-20 ethylene oxide units.

A further class of nonionic surfactants, which can be used as ingredients of the composition of the first component according to the invention, is that of the alkyl polyglycosides (APG). Suitable alkyl polyglycosides satisfy the general Formula RO(G)z where R is a linear or branched, particularly 2-methyl-branched, saturated or unsaturated aliphatic radical containing 8 to 22 and preferably 12 to 18 carbon atoms and G stands for a glycose unit containing 5 or 6 carbon atoms, preferably glucose. The degree of oligomerization z is a number between about 1.0 and about 4.0 and preferably between about 1.1 and about 1.4.

Silicone containing nonionic surfactants, such as the ABIL B8852 or Silwet 7602, can also be used. An exemplary silicone-containing surfactant is silicone polybutane.

Examples of amine oxide surfactants include: dimethyldodecylamine oxide, dimethyltetradecylamine oxide; ethylmethyltetradecylamine oxide, cetyldimethylamine oxide, dimethylstearylamine oxide, cetylethylpropylamine oxide, diethyldodecylamine oxide, diethyltetradecylamine oxide, dipropyldodecylamine oxide, lauryl dimethyl amine oxide, bis-(2-hydroxyethyl) dodecylamine oxide, bis-(2-hydroxyethyl)-3-dodecoxy-1-hydroxypropyl amine oxide, (2-hydroxypropyl)methyltetradecylamine oxide, dimethyloleyamine oxide, dimethyl-(2-hydroxydodecyl)amine oxide, and the corresponding decyl, hexadecyl and octadecyl homologs of the above compounds.

Additional nitrogen-containing surfactants include ethoxylated primary alkyl amines where the alkyl group has 10-20 carbon atoms and the amine is ethoxylated with 2-20 ethylene oxide units.

Additionally, non-ionic surfactants derived from the condensation of ethylene oxide with the product resulting from the reaction of propylene oxide and ethylene diamine are also useful. For example, there are compounds containing from 40% to 80% of polyoxyethylene by weight and having a molecular weight from about 5,000 to about 11,000 resulting from the reaction of ethylene oxide groups with a hydrophobic base constituted of the reaction product from ethylene diamine and excess propylene oxide wherein the base has a molecular weight on order of about 2,500-3,000.

Suitable nonionic surfactants include the polyoxyethylene-polyoxypropylene condensates, which are sold by BASF under the trade name‘Pluronic’, polyoxyethylene condensates of aliphatic alcohols/ethylene oxide condensates having from 1 to 30 moles of ethylene oxide per mole of coconut alcohol; ethoxylated long chain alcohols sold by Shell Chemical Co. under the trade name ‘Neodol’, polyoxyethylene condensates of sorbitan fatty acids, alkanolamides, such as the monoalkoanolamides, dialkanolamides and the ethoxylated alkanolamides, for example coconut monoethanolamide, lauric isopropanolamide and lauric diethanolamide; and amine oxides for example dodecyldimethylamine oxide.

Further exemplary non-ionic surfactants include alkylphenol alkoxylates, and amine oxides such as alkyl dimethylamine oxide or bis(2-hydroxyethyl)alkylamine oxide.

The additional nonionic surfactants can be provided in the composition in an amount of about ≧0 wt.-% to about ≦30 wt.-%, preferably about ≧1 wt.-% to about ≦25 wt.-%, further preferred about ≧5 wt.-% to about ≦20 wt.-%, and more preferred about ≧10 wt.-% to about ≦15 wt.-%, based on the weight of the total first component.

### Anionic Surfactants

The composition of the first component according to the invention is preferably free of anionic surfactants.

Exemplary anionic surfactants that can be used include organic carboxylates, organic sulfonates, organic sulfates, organic phosphates and the like, particularly linear alkylaryl sulfonates, such as alkylarylcarboxylates, alkylarylsulfonates, alkylarylphosphates, and the like. These classes of anionic surfactants are known within the surfactant art as linear alkyl benzyl sulfonates (LABS), alpha olefin sulfonates (AOS), alkyl sulfates, and secondary alkane sulfonates.

The anionic surfactants can be provided in the composition in an amount of about ≧0 wt.-% to about ≦30 wt.-%, preferably about ≧1 wt.-% to about ≦25 wt.-%, further preferred about ≧5 wt.-% to about ≦20 wt.-%, and more preferred about ≧10 wt.-% to about ≦15 wt.-%, based on the weight of the total first component.

### Cationic Surfactans

The presence of the nonionic surfactants enables the use of low levels of higher foaming cationic surfactants, while keeping the foaming at an acceptable level. In a preferred embodiment of the invention, the detergent compositions also comprises a cationic surfactant or an amphoteric surfactant, wherein the cationic or amphoteric surfactant is present in a concentration of about ≧1 wt.-% to about ≦20 wt.-%, preferably about ≧2 wt.-% to about ≦15 wt.-% and more preferably about ≧3 wt.-% to about ≦12% wt.-%, based on the weight of the total first component. Most preferred the composition of the first component according to the invention is free of cationic surfactants.

Suitable cationic surfactants include quaternary ammonium compounds having the formula of RR′R″R′″N⁺X⁻, where R, R′, R″ and R′″ are each a C₁-C₂₄ alkyl, aryl or arylalkyl group that can optionally contain one or more P, O, S or N heteroatoms, and X is F, Cl, Br, I or an alkyl sulfate. Additional preferred cationic surfactants include ethoxylated and/or propoxylated alkyl amines, diamines, or triamines.

Each of R, R′, R″ and R′″ can independently include, individually or in combination, substituents including 6 to 24 carbon atoms, preferably 14 to 24 carbon atoms, and more preferably, 16 to 24 carbon atoms.

Each of R, R′, R″ and R′″ can independently be linear, cyclic, branched, saturated, or unsaturated, and can include heteroatoms such as oxygen, phosphorous, sulfur, or nitrogen. Any two of R, R′, R″ and R′″ can form a cyclic group. Any one of three of R, R′, R″ and R′″ can independently be hydrogen. X is preferably a counter ion and preferably a non-fluoride counter ion. Exemplary counter ions include chloride, bromide, methosulfate, ethosulfate, sulfate, and phosphate.

In an embodiment, the quaternary ammonium compound includes alkyl ethoxylated and/or propoxylated quaternary ammonium salts (or amines).

Preferably, the alkyl group contains between about 6 and about 22 carbon atoms and can be saturated and/or unsaturated. The degree of ethoxylation is preferably between about 2 and about 20, and/or the degree of propoxylation is preferably between about 0 and about 30. In an embodiment, the quaternary ammonium compound includes an alkyl group with about 6 to about 22 carbon atoms and a degree of ethoxylation between about 2 and about 20 A preferred cationic surfactant is commercially available under the name Berol 563 from Akzo-Nobel.

Amphoteric Surfactants

The composition of the first component according to the invention is preferably free of amphoteric surfactants.

Examples of suitable amphoteric surfactants include capryloamphopropionate, disodium lauryl B-iminodipropionate, and cocoamphocarboxypropionate, and disodium octylimino dipropionate.

The amphoteric surfactants can be provided in the composition in an amount of about ≧0 wt.-% to about ≦30 wt.-%, preferably about ≧1 wt.-% to about ≦25 wt.-%, further preferred about ≧5 wt.-% to about ≦20 wt.-%, and more preferred about ≧10 wt.-% to about ≦15 wt.-%, based on the weight of the total first component.

### Alkaline Source

The source of alkalinity can be any source of alkalinity that is compatible with the other components of the cleaning composition. Exemplary sources of alkalinity include alkali metal hydroxides, alkali metal salts, phosphates, amines, and mixtures thereof.

The composition of the first component can be adjusted so by adding the source of alkalinity that a pH-value about ≧11 and about ≦14, preferably of about ≧12 and about ≦13 is achieved. The pH-value is important to provide an optimized reduction in the germs count, such as bacteria, fungi, virus and spores, of the washing washed with detergent composition of the first component of the invention, in combination with the second component of the invention. Significant reduction in the germs count, such as bacteria, fungi, virus and spores, can be achieved for the detergent composition of the first component of the invention in combination with the second component of the invention at a pH-value between about 7 and about 9.5 in the drum or cleaning chamber of a laundry cleaning apparatus, such as a textile washing machine.

Exemplary alkali metal hydroxides include sodium hydroxide, potassium hydroxide, and lithium hydroxide. However, most preferred is sodium hydroxide.

Exemplary alkali metal salts include sodium carbonate, trisodium phosphate, potassium carbonate, and mixtures thereof.

Exemplary phosphates include sodium pyrophosphate, potassium pyrophosphate, and mixtures thereof.

Exemplary amines include alkanolamine selected from the group comprising triethanolamine, monoethanolamine, diethanolamine, and mixtures thereof.

The source of alkalinity, preferably an alkali metal hydroxide, may be added to the composition in a variety of forms, including for example in the form of solid beads, dissolved in an aqueous solution or a combination thereof. Alkali metal hydroxides are commercially available as pellets or beads having a mix of particle sizes ranging from 12-100 U.S. mesh, or as an aqueous solution, as for example, as about 45 wt. %, about 50 wt. % and about 73 wt. % solution.

### Solvents

Suitable solvents include, but are not limited to, water, alcohols, glycols, glycol ethers, esters, and the like, or combinations thereof. Suitable alcohols include, but are not limited to, ethanol, isopropanol (propan-2-ol), 2-butoxy ethanol (butyl glycol), 1-decanol, benzyl alcohol, glycerin, monoethanolamine (MEA), and the like, or combinations thereof.

Suitable glycols include, but are not limited to, ethylene glycol (monoethylene glycol or MEG), diethylene glycol (propylene glycol or butoxy diglycol or DEG), triethylene glycol (TEG), tetraethylene glycol (TETRA EG), glycerin, propylene glycol, dipropylene glycol, hexylene glycol, and the like, or combinations thereof. Preferred solvents are water and/or alcohols. Alcohols that can be suitable used in the composition of the invention of first and second component can be ethanol, propandiol, isopropyl alcohol and/or butylpolyglycol. More preferred is water and most preferred is the addition of a mixture of water and at least one alcohol. The solvent can be added to the first or second component in an amount of about >0 wt.-% to about ≦95 wt.-%, preferably about ≧1 wt.-% to about ≦90 wt.-%, further preferred about ≧10 wt.-% to about ≦85 wt.-%, also preferred about ≧20 wt.-% to about ≦80 wt.-%, in addition preferred about ≧30 wt.-% to about ≦75 wt.-%, furthermore preferred about ≧40 wt.-% to about ≦70 wt.-% and more preferred about ≧50 wt.-% to about ≦60 wt.-%, based on the weight of the total first component or second component, respectively.

### Zeolite

The composition of the first component according to the invention is preferably free of zeolites. However, the composition of the present invention can comprise zeolites. The amount of zeolites can be about ≧2 wt.-% to about ≦40 wt.-%, preferably about ≧10 wt.-% to about ≦35 wt.-%, further preferred about ≧15 wt.-% to about ≦30 wt.-%, and more preferred about ≧20 wt.-% to about ≦25 wt.-%, based on the weight of the total first component.

Suitable zeolites are fine crystalline, synthetic zeolites containing bound water, zeolite A and/or P are preferred. A particularly preferred zeolite P is zeolite MAP (Registered trademark) (a commercial product of Crosfield). However, the zeolites X as well as mixtures of A, X and/or P are also suitable. Commercially available and preferred in the context of the present invention is, for example, also a co-crystallizate of zeolite X and zeolite A (ca. 80 wt. % zeolite X), which is marketed under the name of VEGOBOND AX (Registered trademark) by Condea Augusta S.p.A.

Suitable zeolites have a mean particle size of less than 10 μm (volume distribution, as measured by the Coulter Counter Method) and comprise preferably about ≧18% to about ≦22% by weight and more preferably about ≧5% to about ≦22% by weight of bound water.

### Corrosion Inhibitor

The composition of the first component according to the invention is preferably free of corrosion inhibitor. However, the corrosion inhibitor can be selected from the group comprising silicate, calcium acetate, calcium chloride, calcium gluconate, calcium phosphate, calcium borate, calcium carbonate, calcium citrate, calcium lactate, calcium sulfate, calcium tartrate, benzotriazole, 1,2,3-benzotriazole and mixtures thereof. Exemplary silicates include sodium metasilicates, sesquisilicates, orthosilicates, potassium silicates, and mixtures thereof. However, most preferred can be sodium silicate. The amount of corrosion inhibitor can be about ≧1 wt.-% to about ≦20 wt.-%, preferably about ≧2 wt.-% to about ≦18 wt.-%, further preferred about ≧4 wt.-% to about ≦15 wt.-%, and more preferred about ≧6 wt.-% to about ≦10 wt.-%, based on the weight of the total first component.

Additional corrosion inhibitors which may be optionally added to the composition of this invention include magnesium and/or zinc ions and Ca(NO₂)₂. Preferably, the metal ions are provided in water-soluble form.

Examples of useful water-soluble forms of magnesium and zinc ions are the water-soluble salts thereof including the chlorides, nitrates and sulfates of the respective metals. If any of the alkalinity providing agents are the alkali metal carbonates, bicarbonates or mixtures of such agents, magnesium oxide can be used to provide the Mg ion. The magnesium oxide is water soluble and is a preferred source of Mg ions.

In order to maintain the dispersibility of the magnesium and/or zinc corrosion inhibitors in aqueous solution, and in the presence of agents which would otherwise cause precipitation of the zinc or magnesium ions, e.g., carbonates, phosphates, etc., it might be advantageous to include a carboxylated polymer to the solution.

The useful carboxylated polymers may be generically categorized as water-soluble carboxylic acid polymers such as polyacrylic and polymethacrylic acids or vinyl addition polymers, in addition to the acid-substituted polymers used in the present invention.

Of the vinyl addition polymers contemplated, maleic anhydride copolymers as with vinyl acetate, styrene, ethylene, isobutylene, acrylic acid and vinyl ethers are examples.

The polymers tend to be water-soluble or at least colloidally dispersible in water. The molecular weight of these polymers may vary over a broad range although it is preferred to use polymers having average molecular weights ranging between about 1,000 up to about 1,000,000. These polymers have a molecular weight of about 100,000 or less and between about 1,000 and about 10,000.

The polymers or copolymers (either the acid-substituted polymers or other added polymers) may be prepared by either addition or hydrolytic techniques. Thus, maleic anhydride copolymers are prepared by the addition polymerization of maleic anhydride and another comonomer such as styrene.

The low molecular weight acrylic acid polymers may be prepared by addition polymerization of acrylic acid or its salts either with itself or other vinyl comonomers. Alternatively, such polymers may be prepared by the alkaline hydrolysis of low molecular weight acrylonitrile homopolymers or copolymers.

Exemplary silicates include sodium metasilicates, sesquisilicates, orthosilicates, potassium silicates, and mixtures thereof. The amount of silicate can be about ≧1 wt.-% to about ≦20 wt.-%, preferably about ≧2 wt.-% to about ≦18 wt.-%, further preferred about >3 wt.-% to about ≦15 wt.-%, and more preferred about ≧5 wt.-% to about ≦10 wt.-%, based on the weight of the total first component.

Suitable silicates that can be used may comprise at least one crystalline layer-forming silicate of the general formula NaMSixO2x+1.yH2O, wherein M represents sodium or hydrogen, x is a number from about 1.9 to about 22, preferably about 1.9 to about 4 and y stands for a number from about 0 to about 33.

Clariant GmbH (Germany) markets the crystalline layer-forming silicates of the formula NaMSixO22x+1.yH2O for example under the trade names Na-SKS, eg.

Na-SKS-1 (Na2Si22O45.xH2O, Kenyait), Na-SKS-2 (Na2Si14O29.xH2O, Magadiit), Na-SKS-3 (Na2Si8O17.xH2O) or Na-SKS-4 (Na2Si4O9.xH2O, Makatit).

Crystalline, layered silicates of the above formula, in which x stands for 2 are particularly suitable for the purposes of the present invention.

Na-SKS-5 (alpha-Na2Si2O5), Na-SKS-7 (beta-Na2Si2O5, Natrosilit), Na-SKS-9 (NaHSi2O5.H2O), Na-SKS-10 (NaHSi2O5.3H2O, Kanemit), Na-SKS-11 (t-Na2Si2O5) and Na-SKS-13 (NaHSi2O5) are most notably suitable, particularly Na-SKS-6 (delta-Na2Si2O5).

In the context of the present application, silicates can comprise a content by weight of crystalline layered silicates of formula NaMSixO2x+1.yH2O of about 0.1 to about 20 wt. %, preferably about 0.2 to about 15 wt. % and particularly about 0.4 to about 10 wt. %, each based on the total weight of the corrosion inhibitor agent.

Particularly preferred are especially those that have a total silicate content about >0 and below about ≦7 wt.-%, advantageously below about ≦6 wt.-%, preferably below about ≦5 wt.-%, particularly preferably below about ≦4 wt.-%, quite particularly preferably below about ≦3 wt.-% and especially below about ≦2.5 wt.-%, wherein this silicate, based on the total weight of the comprised silicate, is advantageously at least about ≧70 wt.-%, preferably at least about ≧80 wt.-% and especially at least about ≧90 wt.-% of a silicate of the general formula NaMSixO2x+1.yH2O.

### Hydrotrope Component

It should be understood that the hydrotrope component is optional and can be omitted if it is not needed for stabilizing the surfactant component. In many cases, it is expected that the hydrotrope component will be present to help stabilize the surfactant component. Thus, the composition of the first component according to the invention is preferably free of hydrotrope component. However, the hydrotrope component can be used to help stabilize the surfactant.

Examples of the hydrotropes include the sodium, potassium, ammonium and alkanol ammonium salts of xylene, toluene, ethylbenzoate, isopropylbenzene, naphthalene, alkyl naphthalene sulfonates, phosphate esters of alkoxylated alkyl phenols, phosphate esters of alkoxylated alcohols, short chain (C8 or less) alkyl polyglycoside, sodium, potassium and ammonium salts of the allyl sarcosinates, salts of cumene sulfonates, amino propionates, diphenyl oxides, and disulfonates.

The hydrotropes are useful in maintaining the organic materials including the surfactant readily dispersed in the aqueous cleaning solution and, in particular, in an aqueous emulsion which is an especially preferred form of packaging the first composition of the invention and allow the user of the compositions to accurately provide the desired amount of cleaning composition into the aqueous wash solution.

The hydrotrope component can be provided in the corrosion inhibitor in an amount sufficient to stabilize the surfactant component. When the hydrotrope component is used, it can be provided in an amount of about ≧1 wt.-% to about ≦20 wt.-%, preferably about ≧2 wt.-% to about ≦15 wt.-%, further preferred about ≧4 wt.-% to about ≦10 wt.-%, and more preferred about ≧6 wt.-% to about ≦8 wt.-%, based on the weight of the corrosion inhibitor of the composition according to the present invention.

### Chelant Component

The composition of the first component according to the invention is preferably free of chelant component. However, the composition of the invention can comprise a chelant that exhibits soil removal properties when used at alkaline conditions. The chelant component is provided for tying up metals in the soil to assist in cleaning and detergency. The chelant component can be provided as part of the composition. The chelant component can be provided in the composition in an amount of about ≧1 wt.-% to about ≦30 wt.-%, preferably about ≧2 wt.-% to about ≦20 wt.-%, further preferred about ≧4 wt.-% to about ≦10 wt.-%, and more preferred about ≧6 wt.-% to about ≦8 wt.-%, based on the weight of the total first component. It should be understood that the chelant component can include mixtures of different chelants.

Exemplary chelants that can be used according to the invention include phosphonates, sodium gluconate, pentasodium salt of diethylenetriamine pentaacetic acid (available under the name Versenex 80), sodium glucoheptonate, ethylene diamine tetraacetic acid (EDTA), salts of ethylene diamine tetraacetic acid, hydroxyethyl ethylene diamine triacetic acid (HEDTA), salts of hydroxyethyl ethylene diamine triacetic acid, nitrilotriacetic acid (NTA), salts of nitrilotriacetic acid, diethanolglycine sodium salt (DEG), ethanoldiglycine disodium salt (EDG), tetrasodium N,N-bis(carboxylatomethyl)-L-glutamate (GLDA), and mixtures thereof. Exemplary salts of ethylene diamine tetraacetic acid include disodium salts, tetrasodium salts, diammonium salts, and trisodium salts. An exemplary salt of hydroxyethyl ethylene diamine triacetic acid is the trisodium salt.

Suitable hydroxymonocarboxylic acid compounds include, but are not limited to, citric acid; propionic acid; gluconic acid; glycolic acid; glucoheptanoic acid; succinic acid; lactic acid; methyllactic acid; 2-hydroxybutanoic acid; mandelic acid; atrolactic acid; phenyllactic acid; glyeric acid; 2,3,4-trihydroxybutanoic acid; alpha hydroxylauric acid; benzillic acid; isocitric acid; citramalic acid; agaricic acid; quinic acid; uronic acids, including glucuronic acid, glucuronolactonic acid, galaturonic acid, and galacturonolactonic acid; hydroxypyruvic acid; ascorbic acid; and tropic acid. Preferred hydroxymonocarboxylic acid compounds include citric acid; propionic acid; gluconic acid; glycolic acid; glucoheptanoic acid; and succinic acid. Suitable hydroxydicarboxylic acid compounds include, but are not limited to, tartronic acid; malic acid; tartaric acid; arabiraric acid; ribaric acid; xylaric acid; lyxaric acid; glucaric acid; galactaric acid; mannaric acid; gularic acid; allaric acid; altraric acid; idaric acid; and talaric acid. Preferred hydroxydicarboxylic acid compounds include tartaric acid as well as ethylene diamine tetraacetic acid.

Suitable chelant that can be used in the first component are iminodisuccinate, preferably the sodium salt of iminodisuccinate, hydroxyethylidene diphosphonic acid and/or tetrasodium N,N-bis(carboxylatomethyl)-L-glutamate (GLDA).

It should be understood that the chelant component can include mixtures of different chelants.

### Foam Inhibitor

The composition of the first component according to the invention is preferably free of foam inhibitors. However, suitable non-surface-active foam inhibitors are, for example, organopolysiloxanes and mixtures thereof with microfine, optionally silanised silica and also paraffins, waxes, microcrystalline waxes and mixtures thereof with silanised silica or bis-fatty acid alkylenediamides such as bis-stearyl ethylenediamide. The amount of foam inhibitors can be about ≧1 wt.-% to about ≦10 wt.-%, preferably about ≧2 wt.-% to about ≦9 wt.-%, further preferred about ≧3 wt.-% to about ≦6 wt.-%, and more preferred about ≧4 wt.-% to about ≦5 wt.-%, based on the weight of the total first component.

Mixtures of various foam inhibitors, for example mixtures of silicones, paraffins or waxes, are also used with advantage.

### Dispersion Agents

The composition of the first component according to the invention is preferably free of dispersion agents. However, the composition can comprise dispersion agent. The dispersion agent can be provided in the composition in an amount of about ≧1 wt.-% to about ≦20 wt.-%, preferably about ≧2 wt.-% to about ≦15 wt.-%, further preferred about ≧4 wt.-% to about ≦10 wt.-%, and more preferred about ≧6 wt.-% to about ≦8 wt.-%, based on the weight of the total first component. It should be understood that the dispersion agent can include mixtures of different dispersion agent.

Suitable dispersion agents are polycarboxylic acids, particularly malic acid, tartaric acid, citric acid and sugar acids, monomeric and polymeric aminopolycarboxylic acids, particularly methylglycinediacetic acid, nitrilotriacetic acid and ethylenediaminetetraacetic acid as well as polyaspartic acid, polyphosphonic acids, particularly aminotris(methylenephosphonic acid), ethylenediaminetetrakis(methylenephosphonic acid), hydroxyethylidene diposphoric acid and 1-hydroxyethane-1,1-diphosphonic acid, polymeric hydroxyl compounds such as dextrin as well as (poly)-carboxylic acids, particularly those polycarboxylates obtained from the oxidation of polysaccharides or dextrins, polymeric acylic acids, methacrylic acids, maleic acids and mixed polymers thereof, which can comprise small amounts of copolymerized polymerizable substances exempt from carboxylic acid functionality.

The relative molecular weight MW of the homopolymers of unsaturated carboxylic acids lies generally between about 5000 MW and about 200 000 MW that of the copolymers between about 2000 MW and about 200 000 MW, preferably about 50 000 MW to about 120 000 MW, each based on the free acid.

A particularly preferred acrylic acid-maleic acid copolymer has a relative molecular weight of about 50 000 MW to about 100 000 MW.

Suitable, yet less preferred dispersion agents of this class, are copolymers of acrylic acid or methacrylic acid with vinyl ethers, such as vinyl methyl ethers, vinyl esters, ethylene, propylene and styrene, in which the content of the acid is at least 50 wt. %. Terpolymers, which comprise two unsaturated acids and/or their salts as monomers as well as vinyl alcohol and/or an esterified vinyl alcohol or a carbohydrate, can also be used as water-soluble organic builders.

The first acid monomer or its salt is derived from a monoethylenically unsaturated C₃-C₈-carboxylic acid and preferably from a C₃-C₄-monocarboxylic acid, particularly from (meth)acrylic acid.

The second monomer or its salt can be a derivative of a C₄-C₈-dicarboxylic acid, maleic acid being particularly preferred, and/or a derivative of an allyl sulfonic acid, which is substituted in the 2-position with an alkyl or aryl radical. These types of polymers generally have a relative molecular weight between about 1000 and about 200 000.

Further preferred copolymers are those, which have acrolein and acrylic acid/acrylic acid salts or vinyl acetate as monomers. Polyaspartic acids are particularly preferred.

The dispersion agents can be used in the form of aqueous solutions in the manufacture of the agent, preferably in the form of an about 50 weight percent aqueous solution.

### Other Additives

The composition of the first component according to the invention is preferably free of other additives. However, other additives may be included in the composition according to the present invention.

Other additives may include, but are not limited to dyes, color transfer inhibitors, solvents, Exemplary additional agents include anti-redeposition agents, optical brighteners, sequestrates, builders, water conditioning agents, oil and water repellant agents, color fastness agents, starch/sizing agents, fabric softening agents, souring agents, iron controlling agents, antimicrobials, fungicides, UV absorbers and/or fragrances, and the like.

Color transfer inhibitors are polymers of vinyl pyrrolidone, vinyl imidazole, vinyl pyridine-N-oxide or copolymers thereof. Polymers of vinyl imidazole, vinyl pyrrolidone and copolymers thereof are particularly suitable.

Suitable solvents include alcohols, such as C₂-C₆ alcohols, N-alkyl pyrrolidones, such as a C₈-C₁₈ alkyl pyrrolidone, e.g. N-octyl pyrrolidone, N-lauryl pyrrolidone, and the like.

Lauryl (or n-dodecyl) pyrrolidone is commercially available, for example, as sold by ISF Chemicals under the brand name Surfadone, such as Surfadone LP-300.

Solvents of similar structure can also be used. Such solvents include lactones, such as decanolactone. Other suitable solvents include diacetone alcohol, long chain, e.g. greater than C₆₋alkyl ethers, cyclic alkyl ketones, a 1,2 alkane diol having 5 to 10 carbon atoms such as 1,2 hexanediol, a C₈-C₁₀ alkene carbonate, a pyrrol (such as N-capryl pyrrol, N-lauryl pyrrol, and the like), and mixtures thereof.

The composition of the first component according to the invention may comprises an enzyme material. The enzyme material can be selected from proteases, amylases, lipases, cellulases, peroxidases, and mixtures thereof. The enzyme material can be present in said composition in a concentration of from about 0.001 wt.-% to about 3 wt.-%, based on the weight of the total first component.

### Dyes/Odorants

Various dyes, odorants including perfumes, and other aesthetic enhancing agents may also be included in the composition.

Dyes may be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

Fragrances or perfumes that may be included in the compositions include, for example, terpenoids such as citronellol, aldehydes such as amyl cinnamaldehyde, a jasmine such as C1S-jasmine or jasmal, vanillin, and the like.

For laundry cleaning or sanitizing compositions, preferred dyes and odorants include one or more blue dyes, which can be employed at concentrations up to about 1 wt-%.

### Anti-Redeposition Agents

Anti-redeposition agents can be used to facilitate sustaining a suspension of soils in a use solution and reduce the tendency of the soils to be redeposited onto a substrate from which they have been removed.

Exemplary anti-redeposition agents include fatty acid amides, fluorocarbon surfactants, complex phosphate esters, styrene maleic anhydride copolymers, and cellulosic derivatives such as carboxymethyl cellulose, hydroxyethyl cellulose, hydroxypropyl cellulose, and the like. Specific exemplary anti-redeposition agents include styrene maleic anhydride copolymers, sodium tripolyphosphate, sodium carboxymethyl cellulose, polyvinyl-pyrrolidone, acrylic acid polymers, and maleic/olefinic copolymers. The amount of anti-redeposition agents can be about ≧0.1 wt.-% to about ≦10 wt.-%, preferably about ≧0.2 wt.-% to about ≦5 wt.-%, further preferred about ≧0.3 wt.-% to about ≦1 wt.-%, and more preferred about ≧0.4 wt.-% to about ≦0.5 wt.-%, based on the weight of the total first component.

### Optical Brightener

Optical brightener, referred to as fluorescent whitening agent or fluorescent brightening agent, provides optical compensation for the yellow cast in fabric substrates. With optical brighteners, yellowing is replaced by light emitted from optical brighteners present in the area commensurate in scope with yellow color. The violet to blue light supplied by the optical brighteners combines with other light reflected from the location to provide a substantially complete or enhanced bright white appearance. The brightener through fluorescence produces this additional light. Optical brighteners can absorb light in the ultraviolet range (e.g., 275-400 nm) and can emit light in the ultraviolet blue spectrum (e.g., 400-500 nm).

Fluorescent compounds belonging to the optical brightener family are typically aromatic or aromatic heterocyclic materials often containing condensed ring system. An important feature of these compounds is the presence of an uninterrupted chain of conjugated double bonds associated with an aromatic ring. The number of such conjugated double bonds is dependent on substituents as well as the planarity of the fluorescent part of the molecule.

Most brightener compounds are derivatives of stilbene or 4,4′-diamino stilbene, biphenyl, five membered heterocycles (triazoles, oxazoles, imidazoles, etc.) or six membered heterocycles (cumarins, naphthalamides, triazines, etc.).

The choice of optical brighteners for use in detergent composition of the first components will depend upon a number of factors, such as the type of detergent, the nature of other components present in the detergent composition of the first component, the temperature of the wash water, the degree of agitation, and the ratio of the material washed to the tub size. The brightener selection is also dependent upon the type of material to be cleaned, e.g., cottons, synthetics, etc. Since most laundry detergent products are used to clean a variety of fabrics, the detergent composition of the first components should contain a mixture of brighteners, which are effective for a variety of fabrics. It is of course necessary that the individual components of such a brightener mixture be compatible.

Optical brighteners useful in the present invention are known and commercially available. Commercial optical brighteners which may be useful in the present invention can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles and other miscellaneous agents.

Examples of these types of brighteners are disclosed in ‘The Production and Application of Fluorescent Brightening Agents’, M. Zahradnik, Published by John Wiley & Sons, New York (1982), the disclosure of which is incorporated herein by reference.

Stilbene derivatives which may be useful in the present invention include, but are not necessarily limited to, derivatives of bis(triazinyl)amino-stilbene; bisacylamino derivatives of stilbene; triazole derivatives of stilbene; oxadiazole derivatives of stilbene; oxazole derivatives of stilbene; and styryl derivatives of stilbene. Preferred optical brighteners include stilbene derivatives.

Optical brightners that can be suitable used are 4,4′-bis-(2-sulostyryl)biphenyl (CBS-X) and/or 4,4′-bis-[(4,6-di-anilino-s-triazin-2-yl)-amino]-2,2′-stilbenedisulfonate (DMS-X).

The amount of optical brighteners can be about ≧0.1 wt.-% to about ≦2 wt.-%, and more preferred about ≧0.2 wt.-% to about ≦1 wt.-%, based on the weight of the total first component.

### Sequestrants/Builder

The detergent composition of the first component for low temperature washing and disinfection composition of the invention can include a sequestrant. In general, a sequestrant is a molecule capable of coordinating (i.e., binding) the metal ions commonly found in natural water to prevent the metal ions from interfering with the action of the other detersive ingredients of a cleaning composition. Some chelating/sequestering agents can also function as a threshold agent when included in an effective amount. For a further discussion of chelating agents/sequestrants, see Kirk-Othmer, Encyclopedia of Chemical Technology, Third Edition, volume 5, pages 339-366 and volume 23, pages 319-320. A variety of sequestrants can be used including, for example, organic phosphonate, aminocarboxylic acid, condensed phosphate, inorganic builder, polymeric polycarboxylate, mixture thereof, or the like. Such sequestrants and builders are commercially available.

Suitable condensed phosphates include sodium and potassium orthophosphate, sodium and potassium pyrophosphate, sodium and potassium tripolyphosphate, sodium hexametaphosphate, preferably of tripolyphosphate.

In an embodiment, the composition of the inventionincludes as sequestrant or builder condensed phosphate and polyacrylate, or another polymer, for example, sodium tripolyphosphate and polyacrylate.

Sodium salts of condensed phosphates are preferred to the corresponding potassium salts.

The builder can include an organic phosphonate, such as an organic-phosphonic acid and alkali metal salts thereof. Some examples of suitable organic phosphonates include:
1-hydroxyethane-1,1-diphosphonic acid:
CH₃C(OH)[PO(OH)₂]₂;
aminotri(methylenephosphonic acid):
N[CH₂PO(OH)₂]₃;
aminotri(methylenephosphonate), sodium salt;
2-hydroxyethyliminobis(methylenephosphonic acid): HOCH₂CH₂N[CH₂PO(OH)₂]₂;
diethylenetriaminepenta(methylenephosphonic acid):
(HO)₂POCH₂N[CH₂CH₂N[CH₂PO(OH)₂]₂]₂;
diethylenetriaminepenta(methylene-phosphonate), sodium salt:
C9H(₂₈₋ₓ)N₃NaₓO₁₅P₅ (x=7);
hexamethylenediamine(tetramethylenephosphonate), potassium salt:
C₁₀H(₂₈₋ₓ)N₂KₓO₁₂P₄ (x=6);
bis(hexamethylene)triamine(pentamethylenephosphonic acid):
(HO₂)POCH₂N[CH₂)₆N[CH₂PO(OH)₂]₂]₂; and phosphorus acid H₃PO₃; and other similar organic phosphonates, and mixtures thereof.
2-hydroxyethyliminobis(methylenephosphonic acid):
HOCH₂CH₂N[CH₂PO(OH)₂]₂;
diethylenetriaminepenta(methylenephosphonic acid):
(HO)₂POCH₂N[CH₂CH₂N[CH₂PO(OH)₂]₂]₂;
diethylenetriaminepenta(methylenephosphonate), sodium salt:
C₉H(₂₈₋ₓ)N₃NaₓO₁₅P₅ (x=7);
hexamethylenediamine(tetramethylenephosphonate), potassium salt:
C₁₀H(₂₈₋ₓ)N₂KₓO₁₂P₄ (x=6);
bis(hexamethylene)triamine(pentamethylenephosphonic acid):
(HO₂)POCH₂N[CH₂)₆N[CH₂PO(OH)₂]₂]₂; and
phosphorus acid H₃PO₃; and other similar organic phosphonates, and mixtures thereof.

The sequestrant can be or include aminocarboxylic acid type sequestrant. Suitable aminocarboxylic acid type sequestrants include the acids or alkali metal salts thereof, e.g., amino acetates and salts thereof. Some examples include N-hydroxyethylaminodiacetic acid; hydroxyethylenediaminetetraacetic acid, nitrilotriacetic acid (NTA); methylglycinediacetic acid (MGDA); 2-hydroxyethyliminodiacetic acid (HEIDA); ethylenediaminetetraacetic acid (EDTA); N-hydroxyethyl-ethylenediaminetriacetic acid (HEDTA); diethylenetriaminepentaacetic acid (DTPA); and alanine-N,N-diacetic acid; and the like; and mixtures thereof. Preferred amino carboxylates include the sodium salt of EDTA, MGDA, and HEIDA.

An exemplary sequestrant or builder that can be used includes iminodisuccinic acid (IDS) and salt of iminodisuccinic acid. Such sequestrants are desirable because they are generally considered to be more environmentally friendly compared with other sequestrants.

It should be understood that the sequestrant and/or builder are optional components.

When the composition of the inventionincludes a sequestrant and/or builder, the sequestrant and/or builder can be provided in an amount of about ≧1 wt.-% to about ≦30 wt.-%, preferably about ≧2 wt.-% to about ≦20 wt.-%, further preferred about ≧4 wt.-% to about ≦10 wt.-%, and more preferred about ≧6 wt.-% to about ≦8 wt.-%, based on the weight of the total first component.

### Color Fastness Agents

Exemplary color fastness agents that can be used include polyvinyl pyrrolidone and quaternary amines. It should be understood that the color fastness agents are optional, but when they are used, they can be used in the composition of the first component of the invention in amounts of about ≧0.1 wt.-% to about ≦10 wt.-%, preferably about ≧0.2 wt.-% to about ≦5 wt.-%, further preferred about ≧0.3 wt.-% to about ≦3 wt.-%, and more preferred about ≧0.5 wt.-% to about ≦1 wt.-%, based on the weight of the total first component.

### Softening Agents

The composition of the first component can include softening agents. Exemplary softening agents include quaternary ammonium compounds such as alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof. Exemplary alkylated quaternary ammonium compounds include ammonium compounds having an alkyl group containing between 6 and 24 carbon atoms. Exemplary alkylated quaternary ammonium compounds include monoalkyl trimethyl quaternary ammonium compounds, monomethyl trialkyl quaternary ammonium compounds, and dialkyl dimethyl quaternary ammonium compounds. Examples of the alkylated quaternary ammonium compounds are available commercially under the names Adogen (Registered Trademark), Arosurf (Registered trademark), Variquat (Registered trademark), and Varisoft (Registered trademark). The alkyl group can be a C₈-C₂₂ group or a C₈-C₁₈ group or a C₁₂-C₂₂ group that is aliphatic and saturated or unsaturated or straight or branched, an alkyl group, a benzyl group, an alkyl ether propyl group, hydrogenated-tallow group, coco group, stearyl group, palmityl group, and soya group. Exemplary ring or cyclic quaternary ammonium compounds include imidazolinium quaternary ammonium compounds and are available under the name Varisoft (Registered trademark). Exemplary imidazolinium quaternary ammonium compounds include methyl-1 hydr. tallow amido ethyl-2-hydr. tallow imidazolinium-methyl sulfate, methyl-1-tallow amido ethyl-2-tallow imidazolinium-methyl sulfate, methyl-1-oleyl amido ethyl-2-oleyl imidazolinium-methyl sulfate, and 1-ethylene bis(2-tallow, 1-methyl, imidazolinium-methyl sulfate). Exemplary aromatic quaternary ammonium compounds include those compounds that have at least one benzene ring in the structure. Exemplary aromatic quaternary ammonium compounds include dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds. The alkyl group can contain between 6 and 24 carbon atoms, and can contain between 10 and 18 carbon atoms, and can be a stearyl group or a hydrogenated tallow group. Exemplary aromatic quaternary ammonium compounds are available under the names Variquat (Registered trademark) and Varisoft (Registered trademark). The aromatic quaternary ammonium compounds can include multiple benzyl groups. Diquaternary ammonium compounds include those compounds that have at least two quaternary ammonium groups. An exemplary diquaternary ammonium compound is N-tallow pentamethyl propane diammonium dichloride and is available under the name Adogen 477. Exemplary alkoxylated quaternary ammonium compounds include methyldialkoxy alkyl quaternary ammonium compounds, trialkoxy alkyl quaternary ammonium compounds, trialkoxy methyl quaternary ammonium compounds, dimethyl alkoxy alkyl quaternary ammonium compounds, and trimethyl alkoxy quaternary ammonium compounds. The alkyl group can contain between 6 and 24 carbon atoms and the alkoxy groups can contain between 1 and 50 alkoxy groups units wherein each alkoxy unit contains between 2 and 3 carbon atoms. Exemplary alkoxylated quaternary ammonium compounds are available under the names Variquat (Registered trademark), Varstat (Registered trademark), and Variquat (Registered trademark). Exemplary amidoamine quaternary ammonium compounds include diamidoamine quaternary ammonium compounds. Exemplary diamidoamine quaternary ammonium compounds are available under the name Varisoft (Registered trademark). Exemplary amidoamine quaternary ammonium compounds that can be used according to the invention are methyl-bis(tallow amidoethyl)-2-hydroxyethyl ammonium methyl sulfate, methyl bis(oleylamidoethyl)-2-hydroxyethyl ammonium methyl sulfate, and methyl bis(hydr.tallowamidoethyl)-2-hydroxyethyl ammonium methyl sulfate. Exemplary ester quaternary compounds are available under the name Stephantex (Registered Trademark)

The quaternary ammonium compounds can include any counter ion that allows the component to be used in a manner that imparts fabric-softening properties. Exemplary counter ions include chloride, methyl sulfate, ethyl sulfate, and sulfate.

It should be understood that the softening agents are optional components and need not be present in the composition of the first component of the invention. When fabric softening agents are incorporated into the composition of the invention, they can be included in amounts of about ≧1 wt.-% to about ≦20 wt.-%, preferably about ≧2 wt.-% to about ≦18 wt.-%, further preferred about ≧4 wt.-% to about ≦15 wt.-%, and more preferred about ≧5 wt.-% to about ≦10 wt.-%, based on the weight of the total first component.

### Two Component Detergent Composition

Another object of the present invention is to provide a two component detergent composition for low temperature washing and disinfection, comprising as the first component the detergent composition for low temperature washing and disinfection described above and as a second component comprising at least one bleaching and disinfection composition described below.

The detergent composition of the first component for low temperature washing and disinfection can be separated from the bleaching composition of the second component, which means that the two components of first and second composition are spaced apart from each other.

The pH-value of the bleaching agent is acidic. It can be preferred that the pH-value of the second component of the invention is about ≧0.5 pH to about ≦5 pH, preferably about >0.6 pH to about ≦4 pH, further preferred about ≧0.7 pH to about ≦3 pH, also preferred about ≧0.8 pH to about ≦2 pH and in addition preferred about ≧0.9 pH to about ≦1 pH. Most preferred is a pH-value of the second component of the invention adjusted in the range of 0.7 pH to 0.9 pH.

According to a preferred embodiment of the invention, the detergent composition of the first component for low temperature washing and disinfection is free of a bleaching composition.

The second component containing the bleaching composition can include at least one agent or agents that provide bleaching properties, an agent or agents that provide antimicrobial properties, and agents that provide both bleaching and antimicrobial properties.

The second bleaching component can include at least one bleaching agent. More preferred the second bleaching component can include at least one bleaching agent and additional agents selected from the group comprising at least one aliphatic fatty acid.

Suitable bleaching agent can be fatty acids such as sulfoperoxycarboxylic acids. The sulfoperoxycarboxylic acids are also useful as coupling agents.

Further, bleaching fatty acid agents of the present invention can be derived from non-petroleum based, renewable oils, e.g., castor, toll, soybean, canola, olive, peanut, tallow, rapeseed, and palm oils.

As used herein, the term ‘sulfoperoxycarboxylic acid’ or ‘sulfonated peroxycarboxylic acid’ refers to the peroxycarboxylic acid form of a sulfonated carboxylic acid. The sulfoperoxycarboxylic acids can be used alone, or can be combined with additional ingredients. In some embodiments, compositions of the present invention can include one or more of the sulfoperoxycarboxylic acids as second component.

Peroxycarboxylic (or percarboxylic) acids generally have the formula R(CO₃H)ₙ, where, for example, R is an alkyl, arylalkyl, cycloalkyl, aromatic, or heterocyclic group, and n is one, two, or three, and named by prefixing the parent acid with peroxy. Percarboxylic acids can be made by the direct, acid catalyzed equilibrium action of hydrogen peroxide with the carboxylic acid, by autooxidation of aldehydes, or from acid chlorides, and hydrides, or carboxylic anhydrides with hydrogen or sodium peroxide. The R group can be saturated or unsaturated as well as substituted or unsubstituted.

Sulfoperoxycarboxylic acid, sulfonated peroxycarboxylic acid and/or derivatives thereof that can be used as second component according to the present invention are described in the international application WO 2009/118714 A2, in particular on pages 10, line 6 to page 21 and page 23, line 21 to page 25, and completely included by reference.

According to the invention the bleaching agent can be a sulfoperoxycarboxylic acid of Formula I:

R₁—CH(SO₃⁻X⁺)R₂—COOOH

(Formula I) wherein R₁ is hydrogen, or a substituted or unsubstituted alkyl group; R₂ is a substituted or unsubstituted alkyl group; X is hydrogen, a cationic group, or an ester forming moiety; or salts or esters thereof.

In some embodiments, R₁ is a substituted or unsubstituted Cₘ alkyl group; X is hydrogen a cationic group, or an ester forming moiety; R₂ is a substituted or unsubstituted Cₙ alkyl group; m=1 to 10; n=1 to 10; and m+n is less than 18, or salts, esters or mixtures thereof.

In some embodiments, R₁ is hydrogen. In other embodiments, R₁ is a substituted or unsubstituted alkyl group. In some embodiments, R₁ is a substituted or unsubstituted alkyl group that does not include a cyclic alkyl group. In some embodiments, R₁ is a substituted alkyl group. In some embodiments, R₁ is an unsubstituted C₁-C₉ alkyl group. In some embodiments, R₁ is an unsubstituted C₇ or C₈ alkyl. In other embodiments, R₁ is a substituted C₈-C₁₀ alkyl group. In some embodiments, R₁ is a substituted C₈-C₁₀ alkyl group is substituted with at least 1, or at least 2 hydroxyl groups. In still yet other embodiments, R₁ is a substituted C₁-C₉ alkyl group. In some embodiments, R₁ is a substituted C₁-C₉ substituted alkyl group is substituted with at least 1 SO₃H group.

In other embodiments, R₁ is a C₉-C₁₀ substituted alkyl group. In some embodiments, R₁ is a substituted C₉-C₁₀ alkyl group wherein at least two of the carbons on the carbon backbone form a heterocyclic group. In some embodiments, the heterocyclic group is an epoxide group.

In some embodiments, R₂ is a substituted C₁ to C₁₀ alkyl group. In some embodiments, R₂ is a substituted C₈-C₁₀ alkyl. In some embodiments, R₂ is an unsubstituted C₆-C₉ alkyl. In other embodiments, R₂ is a C₈ to C₁₀ alkyl group substituted with at least one hydroxyl group.

In some embodiments, R₂ is a C₁₀ alkyl group substituted with at least two hydroxyl groups. In other embodiments, R₂ is a C₈ alkyl group substituted with at least one SO₃H group. In some embodiments, R₂ is a substituted C₉ group, wherein at least two of the carbons on the carbon backbone form a heterocyclic group. In some embodiments, the heterocyclic group is an epoxide group.

In some embodiments, R₁ is a C₈-C₉ substituted or unsubstituted alkyl, and R₂ is a C₇-C₈ substituted or unsubstituted alkyl.

In some embodiments, the compound of the invention is selected from the group consisting of:
10-hydroxy-9-sulfooctadecaneperoxoic acid;
9,10-dihydroxy-8-sulfooctadecaneperoxoic acid;
9-sulfooctadecaneperoxoic acid;
11-sulfoundecaneperoxoic acid;
10,11-disulfoundecaneperoxoic acid;
8-(3-octyloxiran-2-yl)-8-sulfooctaneperoxoic acid;
9,10-dihydroxy-11-sulfooctadecaneperoxoic acid;
9-(1-sulfoheptyloxiran-2-yl)-9-nonaneperoxoic acid;
9-hydroxy-10-sulfooctadecaneperoxoic acid;
10-sulfooctadecaneperoxoic acid;
9,10-disulfooctadecaneperoxoic acid;
10-sulfoundecaneperoxoic acid;
9-(3-octyloxiran-2-yl)-9-sulfononaneperoxoic acid;
10,11-dihydroxy-9-sulfooctadecaneperoxoic acid;
8,9-dihydroxy-10-sulfooctadecaneperoxoic acid;

In some embodiments, the bleaching material for the preparation of a peroxycarboxylic fatty acid bleaching agent can be a sulfonated fatty acid.

Without wishing to be bound by any particular theory, it is thought that the sulfo-group is inert in an oxidative environment. Further, it is thought that the hydrophility of the sulfo-group is not as impacted by pH as other substituents. In some embodiments, the sulfonated percarboxylic acids for use as bleaching agents are formed from commercially available sulfonated fatty acids. In other embodiments, the bleaching agents are formed from commercially available non-sulfonated fatty acids, which can be sulfonated. In some embodiments, the bleaching fatty acid will be sulfonated prior to conversion to a peroxycarboxylic acid. In other embodiments, the bleaching fatty acid will be sulfonated at the same time or after the formation of the peroxycarboxylic acid.

Sulfonated fatty acids suitable for use in forming bleaching compounds include, but are not limited to, 11-sulfoundecanoic acid, 10,11-disulfoundecanoic acid, sulfonated oleic acid, sulfonated linoleic acid, sulfonated palmitic acid and sulfonated stearic acid.

Without wishing to be bound by any particular theory it is thought that in some embodiments of the bleaching second component, the sulfonated acid product of the second bleaching component includes about ≧20 to about ≦25 wt.-% of 10-hydroxy-9-sulfooctadecaneperoxoic acid, and/or about ≧20 to about ≦25 wt.-% of 10,11-dihydroxy-9-sulfooctadecaneperoxoic acid, and/or about ≧20 to about ≦25 wt.-% of 9-Hydroxy-10-sulfooctadecaneperoxoic acid, and/or about ≧20 to about ≦25 wt.-% of 8.9-dihydroxy-10-sulfooctadecaneperoxoic acid, based on the total weight of the second component. That is, it is thought that because the sulfonated peroleic acid bleaching material is derived from naturally occurring sources, it is not chemically pure, i.e., does not contain only one form of the sulfonated peroleic acid. The remainder of the product is thought to include about 5 wt.-% to about 10 wt.-% of a mixture of these compounds.

The sulfoperoxy acids can be formed using a variety of reaction mechanisms. For example, in some embodiments, the peracids are formed by the direct acid catalyzed equilibrium action of hydrogen peroxide with the bleaching materials. In some embodiments, the sulfonated carboxylic acids for use in forming the compounds of the present invention are not sulfonated at the alpha-position. It has been found that having the sulfonate group at the alpha position of the fatty acid prohibits the oxidation and/or perhydrolysis of the carboxylic acid group to form the corresponding peroxycarboxylic acid.

In some aspects, the bleaching components including a sulfonated peroxycarboxylic acid compound of Formula I, or mixture thereof.

According to a more preferred embodiment of the invention the second bleaching composition can comprise acetic acid, hydroxyethylene diphosphonic acid, sulfonated oleic acid, octanoic acid, H2O₂ and water.

The second component containing the bleaching composition can comprise more preferred aliphatic fatty acids including oleic acid, palmitic acid, stearic acid, C₃-C₂₆ fatty acids that may be saturated or unsaturated, and sulfonated forms of fatty acids. An exemplary aromatic fatty acid includes phenylstearic acid. Most preferred, the oleic acid and/or derivatives thereof can be contained in the second component. Suitable derivatives of oleic acid can be sulfonated oleic acid, peroxy oleic acid and/or sulfonated peroxy oleic acid. However, oleic acid and/or derivatives thereof can be suitable used in the second component.

The oleic acid and/or derivatives thereof can be included in the second component in amounts of about ≧0 wt.-% to about ≦25 wt.-%, preferably about ≧0.1 wt.-% to about ≦15 wt.-%, further preferred about ≧0.5 wt.-% to about ≦10 wt.-%, and more preferred about ≧1 wt.-% to about ≦5 wt.-%, based on the weight of the total second component.

The used amount of bleaching of the composition of the second component of the invention can be significantly reduced, since the nonionic low alkoxylated alcohol tenside containing 1 to 2 alkylene oxide units shows an increased reduction in the germs count, such as bacteria, fungi, virus and spores, of laundry items washed with it. Due to the required minor amount of bleaching agent, the two-component composition is remarkable mild. Thus, the two-component composition in use neither damages the textile material nor the color of the treated textiles even with so-called functional textiles, does not cause any running of the colors and provides an antistatic finish as well as a soft feel to the washed textiles and the retention of an eventual hydrophobic impregnation.

The ratio of (a) low ethoxylated alcohol of the first component of the invention to the bleaching agent(s) of the second component under use conditions can be in the range of about 10:1 to about 1:10, preferably about 5:1 to about 1:10, further preferred about 2:1 to about 1:10, also preferred about 1:1 to about 1:10, more preferred about 1:1 to about 1:7, and most preferred about 1:1 to 1:5.

The ratio of (a) low ethoxylated alcohol 2EO of the first component of the invention to aliphatic fatty acid, preferably an octanoic acid, also preferred a sulfonated fatty acid, further preferred an oleic acid and more preferred of a sulfonated oleic acid, of the second component can be in the range of about 10:1 to about 1:25, preferably about 5:1 to about 1:20, further preferred about 5:1 to about 1:15, also preferred about 2:1 to about 1:12, more preferred about 2:1 to about 1:10, and most preferred about 1:1 to about 1:8.

The ratio of (a) low ethoxylated alcohol 2EO of the first component of the invention to a peroxy acetic acid of the second component can be in the range of about 10:1 to about 1:20, preferably about 5:1 to about 1:15, further preferred about 5:1 to about 1:12, also preferred about 2:1 to about 1:10, more preferred about 2:1 to about 1:8, and most preferred about 1:1 to about 1:5.

The ratio of (a) low ethoxylated alcohol 2EO of the first component of the invention to a peroxy acid of C₁ to C₁₄, preferably C₂ to C₁₂, also preferred C₃ to C₁₀, and furthermore preferred C₄ to C₉, of the second component can be in the range of about 30:1 to about 1:5, preferably about 25:1 to about 1:4, further preferred about 20:1 to about 1:3, also preferred about 15:1 to about 1:2, more preferred about 10:1 to about 1:1, and most preferred about 5:1 to about 1:1.

The second component containing the bleaching composition can be provided in the form of a concentrate that is diluted with water to provide a use solution. This use solution can be used in a bleaching step for bleaching articles such as laundry items.

Bleaching agents including halogen bleaches are not preferred. The addition of a halogen bleach is optional but it is preferred that the second component does not contain halogen bleaches.

Oxygen bleaches that can be used include those that provide a source of active oxygen. Sources of active oxygen can include inorganic compositions, organic compositions, and mixtures of inorganic and organic compositions. Examples of sources of active oxygen include peroxygen compounds and peroxygen compound adducts. Exemplary peroxygen compositions that can be used include inorganic peroxygen compositions, organic peroxygen compositions, and mixtures thereof.

The composition of the second component can include inorganic active oxygen in an amount of about ≧1 wt.-% to about ≦45 wt.-%, preferably about ≧5 wt.-% to about ≦40 wt.-%, further preferred about ≧10 wt.-% to about ≦35 wt.-%, also preferred about ≧15 wt.-% to about ≦30 wt.-% and more preferred about ≧20 wt.-% to about ≦25 wt.-%, based on the weight of the total second component.

Examples of inorganic active oxygen compositions that can be used include the following types of compositions or sources of compositions, or alkali metal salts, or adducts, or mixtures: hydrogen peroxide; ozone;

Group 1 comprises active oxygen compounds, for example lithium peroxide, sodium peroxide, and the like;

Group 2 comprises active oxygen compounds, for example magnesium peroxide, calcium peroxide, strontium peroxide, barium peroxide, and the like;

Group 3 comprises active oxygen compounds, for example zinc peroxide, and the like;

Group 4 comprises active oxygen compounds, for example boron compounds, such as perborates, for example sodium perborate hexahydrate of the formula Na2-[B₂(O₂)₂(OH)₄]6H₂O (also called sodium perborate tetrahydrate and formerly written as NaBO₃4H2O); sodium peroxyborate tetrahydrate of the formula Na2B₂(O₂)₂[(OH)₄]4H2O (also called sodium perborate trihydrate, and formerly written as NaBO₃3H₂O); sodium peroxyborate of the formula Na2-[B₂(O₂)₂(OH)₄] (also called sodium perborate monohydrate and formerly written as NaBO₃H2O); and the like; preferably perborate;

Group 5 comprises active oxygen compounds, for example persilicates and peroxycarbonates, which are also called percarbonates, such as persilicates or peroxycarbonates of alkali metals; and the like; preferably percarbonate;

Group 6 comprises active oxygen compounds, for example peroxynitrous acid and its salts; peroxyphosphoric acids and their salts, for example, perphosphates; and the like; preferably perphosphate;

Group 7 comprises active oxygen compounds, for example peroxysulfuric acids and their salts, such as peroxymonosulfuric and peroxydisulfuric acids, and their salts, such as persulfates, for example, sodium persulfate; and the like; preferably persulfate;

Group 8 comprises active oxygen compounds such as sodium periodate, potassium perchlorate and the like.

Other active inorganic oxygen compounds can include transition metal peroxides; and other such peroxygen compounds, and mixtures thereof.

The compositions and methods can employ certain of the inorganic active oxygen compounds listed above. Exemplary inorganic active oxygen compounds include hydrogen peroxide, hydrogen peroxide adduct, ozone, active oxygen compounds of group 1, active oxygen compounds of group 2, active oxygen compounds of group 3, active oxygen compounds of group 4, active oxygen compounds of group 5, active oxygen compounds of group 6, active oxygen compounds of group 7, active oxygen compounds of group 8 or mixtures thereof.

Examples of inorganic active oxygen compounds include percarbonate, perborate, persulfate, perphosphate, persilicate, or mixtures thereof. Hydrogen peroxide can be formulated as a mixture of hydrogen peroxide and water, e.g., as liquid hydrogen peroxide in an aqueous solution.

Exemplary inorganic active oxygen compounds include hydrogen peroxide adducts. The inorganic active oxygen compounds can include hydrogen peroxide, hydrogen peroxide adduct, or mixtures thereof. Any of a variety of hydrogen peroxide adducts are suitable for use in the present compositions and methods. For example, suitable hydrogen peroxide adducts include alkali metal percarbonate salt, urea peroxide, peracetyl borate, an adduct of H2O₂ and polyvinyl pyrrolidone, sodium percarbonate, potassium percarbonate, mixtures thereof, or the like. Preferred hydrogen peroxide adducts include percarbonate salt, urea peroxide, peracetyl borate, an adduct of H2O₂ and polyvinyl pyrrolidone, or mixtures thereof. Preferred hydrogen peroxide adducts include sodium percarbonate, potassium percarbonate, or mixtures thereof, preferably sodium percarbonate.

Active oxygen compound adducts include those that can function as a source of active oxygen. Exemplary oxygen compound adducts include hydrogen peroxide adducts, peroxyhydrates, alkali metal percarbonates, for example sodium percarbonate (sodium carbonate peroxyhydrate), potassium percarbonate, rubidium percarbonate, cesium percarbonate, and the like; ammonium carbonate peroxyhydrate, and the like; urea peroxyhydrate, peroxyacetyl borate; an adduct of H2O₂ polyvinyl pyrrolidone, and the like, and mixtures of any of the above.

Any of a variety of organic active oxygen compounds can be employed in the second component and methods of the present invention. For example, the organic active oxygen compound can be a peroxycarboxylic acid, such as a mono- or di-peroxycarboxylic acid or an ester peroxycarboxylic acid, an alkali metal salt including these types of compounds, or an adduct of such a compound. However, most preferred is peroxyacetic acid.

In general, it is expected that the composition of the second component can include peroxycarboxylic acid in an amount of about ≧1 wt.-% to about ≦20 wt.-%, preferably about ≧2 wt.-% to about ≦15 wt.-%, further preferred about ≧3 wt.-% to about ≦10 wt.-%, also preferred about ≧4 wt.-% to about ≦9 wt.-% and more preferred about ≧5 wt.-% to about ≦8 wt.-%, based on the weight of the total second component.

Exemplary peroxycarboxylic acids include C₁-C₂₄ peroxycarboxylic acid, salt of C₁-C₂₄ peroxycarboxylic acid, ester of C₁-C₂₄ peroxycarboxylic acid, diperoxycarboxylic acid, salt of diperoxycarboxylic acid, ester of diperoxycarboxylic acid, or mixtures thereof.

Exemplary peroxycarboxylic acids include C₁-C₁₄, preferably C₁-C₁₀, aliphatic peroxycarboxylic acid, salt of C₁-C₁₄, preferably C₁-C₁₀, aliphatic peroxycarboxylic acid, ester of C₁-C₁₄, preferably C₁-C₁₀, aliphatic peroxycarboxylic acid, or mixtures thereof; salts of or adducts of peroxyacetic acid such as peroxyacetyl borate.

Exemplary diperoxycarboxylic acids include C₄-C₁₀ aliphatic diperoxycarboxylic acid, salt of C₄-C₁₀ aliphatic diperoxycarboxylic acid, or ester of C₄-C₁₀ aliphatic diperoxycarboxylic acid, or mixtures thereof; and sodium salt of perglutaric acid, of persuccinic acid, of peradipic acid, or mixtures thereof.

Additional exemplary peroxycarboxylic acids include phthalimido-percarboxylic acid such as phthalimidoperhexanoic acid and phthalimidoperoctanoic acid as described in U.S. application Ser. No. 10/168,426 filed on Jun. 21, 2002, the entire disclosure being incorporated herein by reference. Organic active oxygen compounds include other acids including an organic moiety. Exemplary organic active oxygen compounds include perphosphonic acids, perphosphonic acid salts, perphosphonic acid esters, or mixtures or combinations thereof.

The bleaching composition can include one or more carboxylic acids and one or more peroxycarboxylic acids with a peroxygen compound such as hydrogen peroxide, H2O₂. Typically, however, the composition contains one or more carboxylic acids, an oxidizer, and one or more peroxycarboxylic acids depending on equilibrium. The peroxycarboxylic acid material can be made by oxidizing a carboxylic acid directly to the peroxycarboxylic acid material which is then solubilized in an aqueous compositions of second component. Further, the materials can be made by combining the unoxidized acid with a peroxygen compound such as hydrogen peroxide and/or ozone to generate the peracid in situ prior to blending the peroxycarboxylic acid with other constituents. This is described in U.S. Pat. No. 5,122,538, incorporated by reference herein.

A carboxylic acid is an organic acid (R—COOH) which contains an aliphatic group and one or more carboxyl groups. A carboxyl group is represented by —COOH, and is usually located at a terminal end of the acid. The aliphatic group can be a substituted or unsubstituted group. Common aliphatic substituents may include —OH, —OR, —NO2, halogen, and other substituents common on these groups. An example of a simple carboxylic acid is acetic acid, which has the formula CH₃COOH. A peroxycarboxylic acid is a carboxylic acid which has been oxidized to contain a terminal —COOOH group. The term peroxy acid is often used to represent a peroxycarboxylic acid. An example of a simple peroxy acid is peroxyacetic acid, which has the formula CH₃COOOH.

The peroxycarboxylic acid can be formulated by combining a monocarboxylic acid, such as acetic acid, with an oxidizer such as hydrogen peroxide and/or ozone. The result of this combination is a reaction producing a peroxycarboxylic acid, such as peroxyacetic acid, and water. The reaction follows an equilibrium in accordance with the following equation:

H2O₂+CH₃COOHCH₃->CH₃COOOH+H₂O;

wherein the pk_{eq} is about 1.7.

The importance of the equilibrium results from the presence of hydrogen peroxide, the carboxylic acid and the peroxycarboxylic acid in the same composition at the same time. Because of this equilibrium, a mixture of carboxylic acid and peroxycarboxylic acid can be combined in water without adding hydrogen peroxide. If permitted to approach equilibrium, the mixture will evolve hydrogen peroxide. This combination provides enhanced sanitizing with none of the deleterious environmental effects of other sanitizing agents, additives, or compositions.

Carboxylic acids have the formula R—COOH wherein the R may represent any number of different groups including aliphatic groups, alicyclic groups, aromatic groups, heterocyclic groups, all of which may be saturated or unsaturated. Carboxylic acids also occur having one, two, three, or more carboxyl groups. Aliphatic groups can be further differentiated into three distinct classes of hydrocarbons. Alkanes (or paraffins) are saturated hydrocarbons. Alkenes (or olefins) are unsaturated hydrocarbons which contain one or more double bonds and alkynes (or acetylenes) are unsaturated hydrocarbons containing one or more highly reactive triple bonds.

Alicyclic groups can be further differentiated into three distinct classes of cyclic hydrocarbons. Cycloparaffins are saturated cyclic hydrocarbons. Cycloolefins are unsaturated cyclic hydrocarbons which contain one or more double bonds while cycloacetylenes are unsaturated cyclic hydrocarbons containing one or more highly reactive triple bonds. Aromatic groups are defined as possessing the unsaturated hydrocarbon ring structure representative of benzene. Heterocyclic groups are defined as 5 or 6 member ring structures wherein one or more of the ring atoms are not carbon. An example is pyridine, which is essentially a benzene ring with one carbon atom replaced with a nitrogen atom.

Carboxylic acids have a tendency to acidify aqueous compositions in which they are present as the hydrogen atom of the carboxyl group is active and may appear as a cation. The carboxylic acid constituent within the present composition when combined with aqueous hydrogen peroxide generally functions as an antimicrobial agent as a result of the presence of the active hydrogen atom. The composition of the invention can utilize carboxylic acids containing as many as 10 carbon atoms. Examples of suitable carboxylic acids include formic, acetic, propionic, butanoic, pentanoic, hexanoic, heptanoic, octanoic, nonanoic, decanoic, lactic, maleic, ascorbic, citric, hydroxyacetic, neopentanoic, neoheptanoic, oxalic, malonic, succinic, glutaric, adipic, pimelic and subric acid.

Carboxylic acids which are generally useful are those having one or two carboxyl groups where the R group is a primary alkyl chain having a length of C₂ to C₁₀, preferably C₂ to C₅ and which are freely water soluble. The primary alkyl chain is that carbon chain of the molecule having the greatest length of carbon atoms and directly appending carboxyl functional groups. Especially useful are mono- and dihydroxy substituted carboxylic acids including alpha-hydroxy substituted carboxylic acid. A preferred carboxylic acid is acetic acid, which produces peroxyacetic acid to increase the sanitizing effectiveness of the materials.

An exemplary peroxycarboxylic acid composition that can be used according to the invention includes medium chain peroxycarboxylic compositions such as those containing peroxyoctanoic acid compositions. Exemplary medium chain peroxycarboxylic acid compositions that can be used include those described in U.S. application 2005/0152991 A1 that was filed with the United States Patent and Trademark Office on Jan. 9, 2004, the entire disclosure of which is incorporated herein by reference.

The oxidized carboxylic acid or peroxycarboxylic acid provides heightened antimicrobial efficacy when combined with hydrogen peroxide and the carboxylic acid in an equilibrium reaction mixture. Peroxycarboxylic acids generally have the formula R(CO₃H)ₙ, where R is an alkyl, arylalkyl, cycloalkyl, aromatic or heterocyclic group, and n is one or two and named by prefixing the parent acid with peroxy. The alkyl group can be a paraffinic hydrocarbon group which is derived from an alkane by removing one hydrogen from the formula. The hydrocarbon group may be either linear or branched, having up to 9 carbon atoms. Simple examples include methyl (CH₃) and ethyl (CH₂CH₃). An arylalkyl group contains both aliphatic and aromatic structures. A cycloalkyl group is defined as a cyclic alkyl group.

While peroxycarboxylic acids are not very stable, their stability generally increases with increasing molecular weight. Thermal decomposition of these acids may generally proceed by free radical and nonradical paths, by photodecomposition or radical-induced decomposition, or by the action of metal ions or complexes.

Peroxycarboxylic acids may be made by the direct, acid catalyzed equilibrium action of 30-98 wt. % hydrogen peroxide with the carboxylic acid, by autoxidation of aldehydes, or from acid chlorides, acid anhydrides, or carboxylic anhydrides with hydrogen or sodium peroxide.

Peroxycarboxylic acids useful in this invention include peroxyformic, peroxyacetic, peroxypropionic, peroxybutanoic, peroxypentanoic, peroxyhexanoic, peroxyheptanoic, peroxyoctanoic, peroxynonanoic, peroxydecanoic, peroxylactic, peroxymaleic, peroxyascorbic, peroxyhydroxyacetic, peroxyoxalic, peroxymalonic, peroxysuccinic, peroxyglutaric, peroxyadipic, peroxypimelic and peroxysubric acid and mixtures thereof.

These peroxycarboxylic acids have been found to provide good antimicrobial action with good stability in aqueous streams.

Peroxyacetic acid is a peroxycarboxylic acid with a structure as given the formula:

CH3-C(═O)—O—OH;

wherein the peroxy group, —O—O—, is considered a high energy bond. Generally, peroxyacetic acid is a liquid having an acrid odor and is freely soluble in water, alcohol, ether, and sulfuric acid. Peroxyacetic acid may be prepared through any number of means known to those of skill in the art including preparation from acetaldehyde and oxygen in the presence of cobalt acetate. A 50% solution of peroxyacetic acid may be obtained by combining acetic anhydride, hydrogen peroxide and sulfuric acid.

The composition of the second component can provide antibacterial activity against a wide variety of microorganisms such as gram positive (for example, Staphylococcus aureus) and gram negative (for example, Escherichia coli) microorganisms, yeast, molds, bacterial spores, viruses, etc. When combined, the above peroxy acids can have enhanced activity compared to the low molecular weight peroxy acids alone.

When the second composition of the second component of the invention includes peroxycarboxylic acid, the peroxycarboxylic acid can be provided in an amount that provides the desired bleaching properties when bleaching conditions are favored and the desired antimicrobial properties when antimicrobial properties are favored.

The composition of the second component can be provided so that it includes a sufficient amount of the bleaching agent to provide the desired amount of bleaching properties and antimicrobial properties in the desired length of time. In general, it is expected that the bleaching properties will determine the amount of the bleaching agent for the composition. That is, it is expected that more of the bleaching agent will be required for achieving the bleaching results than for providing the antimicrobial results. In general, the amount of the bleaching agent used should be sufficient to provide the desired bleaching effect and antimicrobial effect. However, it should be understood that the upper amount of the bleaching agent can be determined based upon cost considerations. It is expected that the amount of bleaching agent(s) in the use composition for treating laundry will be at least 5 ppm, and can be about ≧10 ppm and about ≦2,500 ppm, can be about ≧20 ppm and about ≦1000 ppm, can be about ≧30 ppm and about ≦500 ppm, can be about ≧40 ppm and about ≦300 ppm, can be about ≧50 ppm and about ≦270 ppm, can be about ≧60 ppm and about ≦250 ppm, can be about ≧70 ppm and about ≦230 ppm, can be about ≧80 ppm and about ≦210 ppm, and can be most preferred about ≧100 ppm and about ≦200 ppm.

When used for hard surface cleaning (such as ware washing), the use composition can contain the bleaching agent in an amount of at least about 1 ppm, between about 1 ppm and about 200 ppm, and between about 5 ppm and about 100 ppm.

### Activator

In some embodiments, the antimicrobial activity and/or bleaching activity of the composition of the second component of the invention can be enhanced by the addition of a material which, when the composition is placed in use, reacts or somehow interacts to form an activated component. For example, in some embodiments, a peracid or a peracid salt can be formed. For example, in some embodiments, tetraacetylethylene diamine can be included within the composition to react with active oxygen and form a peracid or a peracid salt that acts as an antimicrobial and bleaching agent. Other examples of active oxygen activators include transition metals and their compounds, compounds that contain a carboxylic, nitrale, or ester moiety, or other such compounds known in the art. Additional exemplary activators include sodium nonanonyloxydenzene sulfonate (NOBS), acetyl caprolactone, and N-methyl morpholinium acetonitrile and salts thereof (such as Sokalan BMG from BASF).

When the composition of the second component of the invention includes an activator, the activator can be provided in an amount of about ≧0.5 wt.-% to about ≦5 wt.-%, preferably about ≧1 wt.-% to about ≦4 wt-% and more preferred about ≧2 wt.-% to about ≦3 wt.-%, based on the weight of the total second component.

### pH Adjusting Agent

The pH value of the cleaning and disinfecting composition of the first component as well as the pH value of the bleaching composition of the second component can be adjusted by adding a pH adjusting agent and/or can be provided as a result a carryover effect, if present, from a prior washing process step. In addition, the pH of the cleaning and disinfecting composition of the first component as well as the pH value of the bleaching composition of the second component can be provided as a result of components in the first and second component of the invention. The cleaning and disinfecting composition can be provided with a pH that favors cleaning and antimicrobial properties. The pH of the bleaching composition of the second component can be adjusted by the introduction of a pH adjusting agent to provide a pH that favors bleaching properties.

The pH of the first and second component can be adjusted by the introduction of a pH adjusting agent that can be an acid or a base. Adjusting the pH of the first and/or second component of the invention includes adjusting a concentrated solution and/or a use solution thereof. The pH adjusting agent can be added to the use composition of the first and/or second component of the invention when it is desired to provide the pH shift. Alternatively, the pH adjusting agent can be provided as part of the cleaning and disinfecting composition of the first component as and/or of the bleaching composition of the second component and can be provided in a form that allows it to take effect at a certain point in time. For example, the pH adjusting agent can be coated in a manner that provides for release of the pH adjusting agent after a length of time. In addition, the pH-adjusting agent can be a component that is generated as a result of a reaction. Accordingly, the pH-adjusting agent can provide the desired pH shift to a second pH after the composition has been provided at the first pH for a desired length of time.

When the pH adjusting agent is used to increase the pH, it can be referred to as an alkaline agent. Exemplary alkaline agents that can be used has been already mentioned above and referred to as “source of alkalinity”. Most preferred can be NaOH in an aqueous solution and in a variety of solid forms in varying particle sizes.

When the pH adjusting agent is used to lower the pH, it can be referred to as an acidifying agent. Exemplary acidifying agents include inorganic acids, organic acids, and mixtures of inorganic acids and organic acids. Exemplary inorganic acids that can be used include mineral acids such as sulfuric acid, nitric acid, hydrochloric acid, and phosphoric acid. Exemplary organic acids that can be used include carboxylic acids including monocarboxylic acids and polycarboxcylic acids such as dicarboxcylic acids. Exemplary carboxylic acids include aliphatic and aromatic carboxylic acids. Exemplary aliphatic carboxylic acids include acetic acid, formic acid, halogen-containing carboxylic acids such as chloroacetic carboxylic acid, and modified carboxylic acids containing side groups such —OH, —R, —OR, -(EO)ₓ, —(PO)_{X}, —NH₂, and —NO₂ wherein R is a C₁ to C₁₀ alkyl group. Exemplary aromatic carboxylic acids include benzoic carboxylic acid, salicylic carboxylic acid, and aromatic carboxylic acid modified to include as a side group at least one of halogen, —OH, —R, —OR, -(EO)x, —(PO)ₓ, —NH₂, and —NO₂ wherein R is a C₁ to C₁₀ alkyl group. Additional exemplary organic acids include oxalic acid, phthlaic acid, sebacic acid, adipic acid, citric acid, maleic acid, and modified forms thereof containing side groups including halogen, —OH, —R, —OR, -(EO)ₓ, —(PO)ₓ, —NH₂, and —NO₂ wherein R is a C₁ to C₁₀ alkyl group. It should be understood that the subscript ‘x’ refers to repeating units. Additional exemplary organic acids include fatty acids such as aliphatic fatty acids and aromatic fatty acids. Exemplary aliphatic fatty acids include oleic acid, palmitic acid, stearic acid, C₃-C₂₆ fatty acids that may be saturated or unsaturated, and sulfonated forms of fatty acids. An exemplary aromatic fatty acid includes phenylstearic acid. Additional acids that can be used include peroxycarboxylic acid such as peroxyacetic acid, and phthalimidopercarboxylic acids. Additional acidic pH adjusting agents include carbon dioxide and ozone.

The pH can be adjusted by adding the pH adjusting agent and/or by allowing the pH adjusting agent to cause a pH shift. For example, the pH adjusting agent can be formed in situ by reaction and/or the pH adjusting agent can be coated and, once the coating is degraded, the pH adjusting agent can become exposed to the composition of first and/or second component.

### Laundry Cleaning Process

Another object of the present invention is to provide a method for removing soil from a laundry item as well as significantly reducing the germs count, such as bacteria, fungi, virus and spores, at low washing temperature. Laundry cleaning processes can include processes such as flushing, sudsing, draining, bleaching, rinsing, extracting, repetitions thereof, or combinations thereof.

Flushing can include contacting the laundry item with a flushing composition. In an embodiment, flushing is the initial wetting step in the machine that carries out the washing procedure. A method of cleaning laundry can include flushing one, two, or more times. Conventional flushing compositions are water (e.g., soft or tap water). In conventional systems, flushing can separate loose soil from and wet a laundry item, but little more. Flushing can be referred to as presoaking, preflushing, or prewashing. According to the present invention, flushing includes or can be contacting the laundry item with a penetrant composition. In an embodiment, contacting with penetrant composition precedes contact of the laundry item with sudsing and/or bleaching composition. Preferably, contacting with penetrant composition precedes contact of the laundry item with any composition other than water.

Sudsing, can be referred to as “washing”, includes cleaning the laundry item with the cleaning and disinfecting composition of the first component of the invention. The detergent composition for cleaning and disinfecting of the first component of the invention can herein be referred to as “cleaning composition”. The cleaning composition of the invention typically includes surfactants and other cleaners, and can include a bleach. However, a more preferred cleaning composition of the first component of the invention is free of any bleaching agent. Sudsing can follow flushing.

According to the present invention, sudsing and other cleaning processes follow contacting with the penetrant composition. In an embodiment, contacting with the penetrant composition can occur during the sudsing cycle, but before addition of sudsing cleaning composition. In an embodiment, sudsing includes contacting a penetrant-treated laundry item with a sudsing cleaning composition.

Draining includes removing a cleaning, flushing, or other composition from the laundry item, for example, by gravity and/or centrifugal force. Draining can follow sudsing. Draining can occur between repeats of flushing.

Bleaching can include cleaning the laundry item with a bleach composition. Bleaching can follow draining and/or sudsing.

Rinsing can include contacting the laundry item with a rinse composition suitable for removing remaining cleaning (sudsing and/or bleach) composition. The rinse composition can, for example, be water (e.g., soft or tap water), a sour rinse, or a rinse including softener. A method of cleaning laundry can include one, two, three, or more rinses. Rinsing can follow bleaching and/or sudsing.

Extracting can include removing a rinse composition from the laundry item, typically with centrifugal force. Extracting can follow one or more rinsings.

The laundry item can be processed in a laundry washing machine like a washer extractor or a tunnel washer. A washer extractor that can be used includes a drum having an interior for holding laundry, a motor constructed and arranged for rotating the drum, a water inlet for introducing water into the drum interior, a chemical inlet for introducing chemicals into the drum interior, a drain for allowing fluid to drain from the drum interior, and a processing unit constructed for operating the washer extractor. The processing unit can be constructed to provide a washing cycle for washing laundry with a cleaning and disinfecting composition solution of the first component, a rinsing cycle for removing at least a portion of the detergent use solution, and a treatment cycle for treating laundry with a bleaching composition of the second component.

The washer extractor can include a second chemical inlet for introducing a pH adjusting agent for adjusting the pH of the bleaching as well as of the cleaning and disinfecting composition.

A tunnel washer consists of several compartments that are arranged in a tunnel-like construction. The laundry remains in each compartment for a certain time and then is transported to the next compartment by top-transfer or bottom-transfer. Each compartment can be connected to a dosing unit that allows the addition of one or more detergent components. In this way, the cleaning and disinfecting composition of the first component and the bleaching and disinfecting composition of the second component, as well as other chemicals for the treatment of the laundry cam be added independently into various compartments of the tunnel washer.

The pH value of a use solution of the cleaning and disinfecting composition of the first component, i.e. in the drum of a washer extractor or in a tunnel washer at work, can be in the range of about ≧7 pH to about ≦14 pH, preferably about ≧9 pH to about ≦14 pH, further preferred about ≧10 pH to about ≦13 pH and more preferred about ≧11 pH to about ≦12 pH.

The pH value of a concentrated solution of the bleaching composition of the second component, i.e. in the drum of a laundry machine at work, can be in the range of about ≧2 pH to about ≦7 pH, preferably about ≧3 pH to about ≦6 pH, further preferred about ≧4 pH to about ≦6 pH and more preferred about ≧5 pH to about ≦6 pH.

The removal of bleachable stains such as grass, tea, coffee, red wine and fruit juice stains on textiles is normally undertaken with the help of a bleaching agent. Normally, a bleaching system is used with a peroxygenated oxidizing agent that forms hydrogen peroxide in water, such as sodium perborate or sodium percarbonate, with a so-called bleach activator, such as TAED, which forms a peroxycarboxylic acid (in the case of TAED peracetic acid) in the aqueous wash solution.

The bleaching treatment can be provided as a finishing step or as a step intended to be followed by subsequent steps.

For example, the use of the bleaching composition of the second component can be followed by subsequent rinsing and/or finishing steps to impart desired benefits to the laundry or other surface being treated.

Alternatively, many of the finishing components can be incorporated into the composition of the second bleaching component to impart the desired benefit during the treatment step.

When used as a finishing composition, it is expected that certain components can be advantageously incorporated into the bleaching composition of the second component of the invention.

In addition, it is expected that many of the components may provide a desired benefit even if the bleaching composition of the second component is not used as a finishing composition.

That is, certain components may provide an advantageous affect when used in the bleaching composition of the second component even when there may be additional steps subsequent to the treatment step.

The method for treating laundry according to the invention can be provided as part of an overall method for cleaning laundry according to the invention. That is, as part of a laundry cleaning operation, the laundry can be treated with a bleaching composition of the second component to provide bleaching properties and a cleaning and disinfection composition of the first component of the invention to provide cleaning and antimicrobial properties.

The nonionic low alkoxylated alcohol tensides of the cleaning and disinfection composition of the first component provides antimicrobial properties. When combined with the bleaching agent of the second component, the antimicrobial properties can be characterized as sanitizing, since there is a substantial reduction of bacteria, fungi, spores, and other microorganisms or microorganism on a surface of a laundry item being treated therewith. A substantial reduction refers to a reduction of at least three orders of magnitude and can be referred to as a three-log 10 reduction. Preferably, the reduction can be at least five orders of magnitude for virus, at least seven orders of magnitude for bacteria, at least 5 orders of magnitude for mycobacteria and at least 6 orders of magnitude for fungi.

The reference to ‘cleaning’ refers to at least one of the removal of soil, the removal of staining or the appearance of staining, and the reduction of a population of germs, such as microbes. A cleaning process can include all three of the removal of soil, the removal of staining or the appearance of staining, and the reduction of a population of germs, such as microbes.

The method for treating laundry refers to the treatment of laundry item with a bleaching composition of the second component that favors bleaching and disinfecting properties and the treatment of laundry item with a cleaning and disinfecting composition of the first component that favors cleaning and antimicrobial properties.

In the method for treating laundry the cleaning and disinfecting composition is used at a pH of first condition and the bleaching agent composition is used at a pH of second conditions. It can be preferred that the pH value of first condition differs from the pH value of the second condition. The pH value can be subjected to a condition shift from the first condition, i.e. cleaning and disinfection composition of first component, to the second condition, i.e. bleaching composition of second component, or vice versa. When the first condition and the second condition refer to a first pH and a second pH, respectively, the composition of first and second components can be subjected to a pH shift from the first pH to the second pH or vice versa.

In the context of the statement that a first condition favors cleaning and disinfecting properties and a second condition favors bleaching and disinfecting properties, it should be understood that the term ‘favors’ reflects a general preference for a particular activity at the identified condition such as a pH environment. In general, it is expected that the preference refers to a speed and sufficiency that provides desirable results whether the operation is carried out commercially or residentially. That is, bleaching of second component is expected to occur sufficiently quickly when bleaching properties are favored, and antimicrobial properties of first component are expected to occur sufficiently quickly when antimicrobial properties are favored. Although a particular activity may be favored in one environment, other activities can also occur in that environment.

The method for treating laundry can be provided for a commercial and/or industrial laundry washing apparatus and can be provided in a residential and/or home laundry washing machine. A tunnel washer, also called a continuous batch washer, is an industrial laundry machine designed specifically to handle heavy loads.

Exemplary commercial and/or industrial laundry washing facilities include those cleaning textiles for the rental, health care, and hospitality industries. In addition, the method for treating laundry can occur as part of an operation the steps of washing, rinsing, finishing, and extracting. In addition, it should be understood that the step of treating laundry can include, as part of the step, additional activities such as, for example, washing and finishing.

It is expected that many commercial and industrial laundry washing machines are capable of handling the method for treating laundry according to the invention. Many commercial and industrial laundry washing machines are computer programmable, and computer programs can be provided to operate the machines according to the invention. In addition, it is expected that machines can be made available to treat laundry according to the invention, and that these machines can be used in both industrial or commercial applications and in home and residential applications. In addition, the compositions of first and second component of the invention can be formulated so that it can be used in commercial and industrial laundry washing machines and residential laundry washing machines that are in common use, that are not computer programmable, and without modification. That is, it is expected that conventional laundry washing machines can be used to treat laundry according to the invention. Method for cleaning and disinfecting laundry items at low temperatures using the detergent composition of the invention or the two component detergent composition of the invention.

The cleaning and disinfecting laundry items can be treated in a cleaning and disinfection process, wherein in a first step the first component the present invention and thereafter in a second step the second component according to the present invention containing at least one bleaching agent is added to the rinsing chamber.

The pH-value after adding the first component of the invention to the washing liquor of a cleaning and disinfecting apparatus, such as a washing mashie, can be in the range of about ≧9 to about ≦13.

The pH-value of the washing liquor after adding the first component and the second component of the invention to the washing liquor of a cleaning and disinfecting apparatus, such as a washing mashie can be in the range of a pH of about ≧8 to about ≦10, preferably of a pH of about ≧8.2 to about ≦9.8, further preferred of a pH of about ≧8.3 to about ≦9.7, also preferred of a pH of about ≧8.4 to about ≦9.6, more preferred of a pH of about ≧8.6 to about ≦9.5 and most preferred of a pH of about ≧8.8 to about ≦9.3.

The length of time sufficient to provide a desired level of cleaning and disinfection of the first and the second component of the invention often depends on the laundry washing machine that is being used. In general, it is expected that sufficient cleaning and disinfection can occur at a time of about ≧1 minutes and about ≦60 minutes, at a time of about ≧5 minutes and about ≦40 minutes, and a time of about ≧10 minutes and about ≦30 minutes. Of course, the amount of time often depends on the temperature of the cleaning and disinfecting process. The temperature of the cleaning and disinfection of the first and the second component of the invention can be provided at about ≧20° C. to about ≦60° C., preferably at about ≧30° C. to about ≦40° C.

The length of time sufficient to provide a desired level of bleaching depends on the laundry washing machine that is being used. In general, it is expected that sufficient bleaching can occur at a time of about ≧1 and about ≦20 minutes, at a time of about ≧2 and about ≦15 minutes, and a time of about ≧3 minutes and about ≦10 minutes. The amount of time often depends on the staining involved and on the temperature of the cleaning process. The temperature of the bleaching composition of second component can be provided at about ≧30° C. to about ≦40° C. Lowering the pH allows the bleaching composition of the second component to favor antimicrobial properties.

The detergent composition for cleaning and disinfection, i.e. first component, can be used as a detergent in institutional and/or household washing machines, as cleaning and—when used in combination with the second component—as disinfecting agent.

The two component detergent composition of first and second component can be used as detergent in institutional and/or household washing machines, as bleaching, cleaning and disinfecting agent.

The present invention may be better understood with reference to the following examples. These examples are intended to be representative of specific embodiments of the invention, and are not intended as limiting the scope of the invention.

### EXAMPLES

The following examples were carried out to illustrate the improved reduction in the germs count, such as bacteria, fungi, virus and spores, of a washing item washed with it according to the invention.

TABLE 1
Detergent composition for cleaning and disinfecting

| First component | E1 | E2 | E3 | E4 | E5 | E6 | V1 |
|---|---|---|---|---|---|---|---|
| composition | Wt.-% | Wt.-% | Wt.-% | Wt.-% | Wt.-% | Wt.-% | Wt.-% |
| Optical brightener DMS-X*¹ | 0, 2 | 0, 2 | 0, 2 | 0, 2 | 0, 2 | 0, 2 | 0, 2 |
| Optical brightener CBS-X*² | 0, 2 | 0, 2 | 0, 2 | 0, 2 | 0, 2 | 0, 2 | 0, 2 |
| Sodium Hydroxide | 15 | 15 | 15 | 15 | 15 | 15 | 15 |
| Hydroxyethylidene | 1 | 1 | 1 | 1 | 1 | 1 | 1 |
| diphosphonic acid | | | | | | | |
| Iminodisuccinate, sodium salt | 1 | 1 | 1 | 1 | 1 | 1 | 1 |
| GLDA*³ | 2 | 2 | 2 | 2 | 2 | 2 | 2 |
| Polycarboxylate*⁴, sodium salt | 1 | 1 | 1 | 1 | 1 | 1 | 1 |
| Isotridecanol ethoxylate (8EO) | 10 | 10 | 0 | 5 | 15 | 15 | 10 |
| Isotridecanol ethoxylate (5EO) | 0 | 0 | 10 | 0 | 0 | 0 | 0 |
| Isotridecanol ethoxylate (4EO) | 0 | 0 | 0 | 5 | 0 | 0 | 0 |
| Isotridecanol ethoxylate (3EO) | 0 | 0 | 0 | 0 | 0 | 0 | 5 |
| Isotridecanol ethoxylate (2EO) | 7 | 0 | 7 | 8 | 10 | 5 | 0 |
| Isotridecanol ethoxylate (1EO) | 0 | 7 | 0 | 0 | 0 | 5 | 0 |
| Acrylic acid polymer | 1 | 1 | 1 | 1 | 1 | 1 | 1 |
| Ad 100 Water | 61, 6 | 61, 6 | 61, 6 | 60, 6 | 53, 6 | 53, 6 | 63, 6 |
| pH-value | 12.1 | 12.3 | 12.2 | 11.8 | 12.1 | 11.9 | 12.1 |

*¹= 4,4′-bis-[(4,6-di-anilino-s-triazin-2-yl)-amino]-2,2′-stilbenedisulfonate (DMS-X)
*²= 4,4′-bis-(2-sulfostyryl)biphenyl (CBS-X)
*³= tetrasodium N,N-bis(carboxylatomethyl)-L-glutamate (GLDA)
*⁴= copolymer of maleic acid and acrylic acid, sodium salt

In table 1 compositions of E1 to E6 refers to cleaning and disinfecting compositions of the first component according to the present invention. The composition V1 is an comparative example.

TABLE 2
Bleaching composition (B1) of second component

| | Wt.-% |
|---|---|
| Acetic acid | 12 |
| Hydroxyethylen diphosphonic acid | 2 |
| Sulfonated oleic acid | 11 |
| Octanoic acid | 4 |
| H₂O₂ (50% solution in water) | 52 |
| Add 100 Water | 19 |
| pH-value | 1.6 |

### Example 1

In 1000 ml water 1.25 ml of composition E1 to E6 and V1 was mixed and added into the rinsing chamber of a washer extractor Electrolux W3654.
In 1000 ml water 2 ml of the bleaching composition B1 was mixed and added afterwards into the rinsing chamber of the washer extractor Electrolux W3654.
The water hardness was adjusted to 0° dH by a Miele Aqua-Soft-System G 7797
The selected wash conditions were 10 minutes wash cycle time, bath ratio 1:5 at a temperature of 40° C.

The washing drum was filled with cotton textiles at a bath ratio of 1:5. Sterilized standard cotton samples (1 cm×1 cm) were immersed in Petri dishes containing the suspensions with the respective germs as shown in table 3 below; contact time: 15 min (several times turned). After drying for 3 hours at 36° C. the carriers were loaded in the wash machine (10 contaminated and 6 non-contaminated carriers in small bags). 12.5 ml defibrinated sheep blood was added per kg laundry before water influx. The carriers were taken out after the disinfection process and before the start of the rinse, transferred into individual tubes, neutralized and homogenized. Different dilutions were prepared and transferred in liquid CSA (tryptone soya agar). The cultures were incubated for 3 days at 36° C. Each of composition E1 to E6 and V1 was tested with 3 contaminated carriers with the germs shown in table 3. The mean values of the reduction factors for each germ and each composition are reported in table 4.

TABLE 3
CFU (colony forming unit) of the initial state of germs in log/ml

| germs | strain | CFU |
|---|---|---|
| Staphylococcus aureus | ATCC 6538 | 8.40 |
| Enterococcus hirae | ATTCC 10541 | 8.46 |
| Escherichia coli K12 | NCTC 10538 | 8.61 |
| Mycobacterium terrae | ATCC 15755 | 8.32 |
| Pseudomonas aeruginosa | ATCC 15442 | 8.26 |
| Candida albicans | ATCC 10231 | 8.66 |

TABLE 4
CFU average reduction factors of germs in log/ml for the washed textiles

| | Staphylococcus | Enterococcus | Escherichia | Mycobacterium | Pseudomonas | Candida |
|---|---|---|---|---|---|---|
| | aureus | hirae | coli K12 | terrae | aeruginosa | albicans |
| E1 | ≧7.01 | ≧7.01 | ≧7.01 | ≧5.88 | ≧7.01 | ≧6.24 |
| E2 | ≧7.1 | ≧7.05 | ≧7.2 | ≧5.45 | ≧7.01 | ≧6.22 |
| E3 | ≧7.15 | ≧7.03 | ≧7.05 | ≧5.22 | ≧7.03 | ≧6.14 |
| E4 | ≧7.05 | ≧7.1 | ≧7.12 | ≧5.35 | ≧7.04 | ≧6.35 |
| E5 | ≧7.01 | ≧7.11 | ≧7.04 | ≧5.24 | ≧7.02 | ≧6.53 |
| E6 | ≧7.12 | ≧7.06 | ≧7.05 | ≧5.36 | ≧7.13 | ≧6.41 |
| V1 | <4 | <3 | <3 | <3 | <4 | <3 |

The use of the detergent composition of the first component according to the invention leads to a significant reduction in the germs count, such as bacteria, fungi, virus and spores, of the washing, damages neither the textile material nor the color of the treated textiles even with so-called functional textiles. Further, it does not cause any running of the colors and provides an antistatic finish as well as a soft feel to the washed textiles and the retention of an eventual hydrophobic impregnation.

The compositions of the present invention can be used for cleaning and disinfecting of a variety of substrates, soft surfaces, e.g., textiles, and/or hard surfaces.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

As used herein, and in particular as used herein to define the elements of the claims that follow, the articles ‘a’ and ‘an’ are synonymous and used interchangeably with ‘at least one’ or ‘one or more,’ disclosing or encompassing both the singular and the plural, unless specifically defined otherwise. The conjunction ‘or’ is used herein in its inclusive disjunctive sense, such that phrases formed by terms conjoined by ‘or’ disclose or encompass each term alone as well as any combination of terms so conjoined, unless specifically defined otherwise. All numerical quantities are understood to be modified by the word ‘about,’ unless specifically modified otherwise or unless an exact amount is needed to define the invention over the prior art.

1-19. (canceled)

20. A low temperature detergent composition for cleaning and disinfecting comprising:
(a) about 2 wt.-% to about 50 wt.-% of a nonionic low alkoxylated alcohol tenside containing 1 to 2 alkylene oxide units;
(b) about 0 wt.-% to about 60 wt.-% of a nonionic higher alkoxylated alcohol tenside containing 3 to 40 alkylene oxide units;
(c) about 1 wt.-% to about 60 wt.-% of a source of alkalinity;
(d) about 0 wt.-% to about 95 wt.-% of at least one solvent; calculated on the total weight amount of the detergent composition.

21. The detergent composition of claim 20, wherein the ratio of low ethoxylated alcohol to source of alkalinity is in the range of about 20:1 to about 1:6.

22. The detergent composition of claim 20, wherein the nonionic low alkoxylated alcohol tenside are primary and/or branched alcohols containing 8 to 18 carbon atoms containing 1 to 2 ethylene oxide groups.

23. The detergent composition of claim 22, wherein the nonionic low alkoxylated alcohol tenside are ethoxylates having 1 to 2 ethylene oxide groups and are selected from the group comprising coco-, palm-, tallow-, oleyl alcohol and/or isotridecyl.

24. The detergent composition of claim 20, wherein the nonionic higher alkoxylated alcohol tensides are linear and/or branched alcohols containing 8 to 18 carbon atoms and 3 to 40 ethylene oxide groups.

25. The detergent composition of claim 20, wherein the sources of alkalinity include alkali metal hydroxides, alkali metal salts, phosphates, amines, and mixtures thereof.

26. The detergent composition of claim 25 wherein the alkali metal hydroxides include sodium hydroxide, potassium hydroxide, and lithium hydroxide, or mixtures thereof.

27. The detergent composition of claim 20, wherein the ratio of low ethoxylated alcohol containing 1 to 2 ethylene oxide groups to nonionic higher alkoxylated alcohol tenside containing 3 to 40 alkylene oxide units is in the range of about 8:1 to about 1:20.

28. The detergent composition of claim 20, wherein the composition has a pH-value between about 11 and about 14.

29. The detergent composition of claim 20, wherein the composition has a viscosity range of from about 200 to about 1500 mPas at about 20° C. measured at about 20 revolutions per minute on a Brookfield RVT viscosimeter with spindle 2.

30. The detergent composition of claim 20, further comprising a bleaching agent, an aliphatic fatty acid or combinations thereof.

31. The detergent composition of claim 30 wherein the aliphatic fatty acid is a sulfoperoxycarboxylic acid with the following formula:
R₁—CH(SO₃⁻X⁺)R₂—COOOH
wherein R₁ is hydrogen, or a substituted or unsubstituted alkyl group; R₂ is a substituted or unsubstituted alkyl group; X is hydrogen, a cationic group, or an ester forming moiety; or salts or esters thereof; more preferred R₁ is a substituted or unsubstituted Cₘ alkyl group; X is hydrogen a cationic group, or an ester forming moiety; R₂ is a substituted or unsubstituted Cₙ alkyl group; m=1 to 10; n=1 to 10; and m+n is less than 18, or salts, esters or mixtures thereof.

32. The detergent composition of claim 30, wherein the ratio of low ethoxylated alcohol to the bleaching agent under use conditions is in the range of about 10:1 to about 1:10.

33. The detergent composition of claim 30, wherein the bleaching agent comprises at least one of a hydrogen peroxide, hydrogen peroxide adduct, active inorganic oxygen compound, peroxycarboxylic acid, ester of peroxycarboxylic acid, an alkaline metal salt of a peroxycarboxylic acid, C₁-C₁₄ aliphatic peroxycarboxylic acid, salt of C₁-C₁₄ aliphatic peroxycarboxylic acid, ester of C₁-C₁₄ aliphatic peroxycarboxylic acid, or mixtures thereof.

34. The detergent composition of claim 30, wherein the bleaching agent comprises at least one peroxide agent in an amount of about 1 wt.-% to about 20 wt.-% based on the weight of the total bleaching agent.

35. The detergent composition of claim 30, wherein the bleaching agent comprises at least one activator agent.

36. A method for cleaning and disinfecting laundry items at low temperatures using the detergent composition of claim 20.

37. The method for cleaning and disinfecting laundry items at low temperatures according to claim 36, wherein in a first step the detergent composition is applied to a washing liquor in a washing machine and thereafter in a second step the bleaching agent is added to a rinsing chamber of the washing machine.

38. The method for cleaning and disinfecting laundry items at low temperatures according to claim 37, wherein the pH-value after adding the detergent composition in the first step in the washing liquor of the washing machine is in the range of about 9 to about 13.

39. The method for cleaning and disinfecting laundry items at low temperatures according to claim 37, wherein the pH-value after adding the bleaching agent in the second step to the rinsing chamber of the washing machine is in the range of about 8 to about 10.
